(19) United States
(12) Patent Application Publication
(10) Pub. No.: US 2019/0092066 A1
(43) Pub. Date: Mar. 28, 2019

(54) PAPER STRENGTHENER COATING DEVICE, SHEET MANUFACTURING APPARATUS, SHEET, AND PAPER STRENGTHENER COATING METHOD

(71) Applicant: SEIKO EPSON CORPORATION, Tokyo (JP)

(72) Inventor: Shinichi KATO, MATSUMOTO-SHI (JP)

(73) Assignee: SEIKO EPSON CORPORATION, Tokyo (JP)

(21) Appl. No.: 16/143,817

(22) Filed: Sep. 27, 2018

(30) Foreign Application Priority Data
Sep. 28, 2017 (JP) 2017-189223

(51) Int. Cl. B41M 5/52; B41J 2/145; B41J 2/175

(52) U.S. Cl. CPC B41M 5/5236; B41J 2/175; B41J 2/145

(57) ABSTRACT

Provided are a paper strengthener coating device, a sheet manufacturing apparatus, a sheet, and a paper strengthener coating method capable of suppressing production of paper dust from sheets when printing on sheets of paper. The paper strengthener coating device has: a solution supply device configured to supply a solution containing a paper strengthener; an inkjet head having nozzles for ejecting the solution supplied from the solution supply device; and a paper strengthener coating unit configured to apply the solution ejected from the nozzles onto a sheet; the inkjet head preferentially or selectively applying the solution to an edge part of the sheet.

### BACKGROUND

### 1. Technical Field

The present invention relates to a paper strengthener coating device, a sheet manufacturing apparatus, a sheet, and a paper strengthener coating method.

### 2. Related Art

Image forming devices that form images on printing paper by ejecting ink droplets from a recording head are known from the literature. In such an image forming device, print media (paper) is supplied to an image forming unit having a recording head, and is discharged to a discharge tray after an image is formed on the surface of the print medium.

When the printing paper passes the image forming unit in such an image forming device, paper dust there may be paper dust from the cut edges of the paper. If the paper dust is then blown around inside the image forming device and sticks to the nozzles of the recording head, the nozzles may become clogged. If the nozzles clog, ink cannot be applied to the image, and the quality of the image formed on the paper drops.

JP-A-2013-107221 describes a method of coating the surface of the printing paper with a liquid paper dust inhibitor to prevent dispersion of paper dust.

However, the method described in JP-A-2013-107221 uses water or ethanol as the liquid paper dust inhibitor, but such liquids evaporate over time and are insufficient for preventing dispersion of paper dust.

### SUMMARY

The present invention provides a paper strengthener coating device, a sheet manufacturing apparatus, a sheet, and a paper strengthener coating method capable of preventing the production of paper dust from sheets when printing on sheets of paper.

The present invention is directed to solving at least part of the foregoing problem, and can be embodied as described below. The present invention is directed to solving at least part of the foregoing problem, and can be embodied as described below.

A paper strengthener coating device according to an aspect of the invention has: a solution supply device configured to supply a solution containing a paper strengthener; an inkjet head having nozzles that eject the solution supplied from the solution supply device; and a paper strengthener coating unit configured to apply the solution ejected from the nozzles onto a sheet; the inkjet head preferentially or selectively applying the solution to an edge part of the sheet.

This aspect of the invention can apply solution to the edge part of a sheet where paper dust is easily produced. This solution contains a paper strengthener that penetrates the edge part of the sheet, and can strengthen bonds between cellulose fibers contained in the sheet. As a result, production of paper dust by cellulose fibers separating from the sheet can be prevented.

Preferably, the paper strengthener coating device also has a conveyance device configured to convey the sheet; the inkjet head includes a top head disposed above the sheet conveyed by the conveyance device and having multiple nozzles arrayed in a direction intersecting a conveyance direction of the sheet; and the top head ejects the solution from the nozzles toward the edge part of the sheet as the sheet passes.

This configuration enables ejecting solution while conveying the sheet, and quickly applying the solution to edge areas of the sheet.

In a paper strengthener coating device according to another aspect of the invention, the multiple nozzles include inside nozzles facing an inside part between edge parts of the sheet, and the top head also ejects the solution from the inside nozzles to the inside part when the sheet passes.

This configuration enables ejecting solution while conveying the sheet, and quickly applying the solution to the inside area of the sheet.

Preferably in a paper strengthener coating device according to another aspect of the invention, the top head also has an adjustment means configured to set the amount of solution ejected to the edge part of the sheet different from the amount of solution ejected to the inside part of the sheet.

This configuration can set the amount of solution applied to the edge areas of the sheet greater than the amount of solution applied to the inside area. The inkjet head is therefore configured to prioritize applying solution to the edge areas of the sheet.

Preferably in a paper strengthener coating device according to another aspect of the invention, the solution includes a first solution and a second solution with different properties; the solution supply device supplies the first solution and the second solution; and the paper strengthener coating unit has a switching means configured to turn the supply of the first solution and the supply of the second solution to the top head on or off.

This configuration enables applying the first solution or applying the second solution to the sheet.

Preferably in a paper strengthener coating device according to another aspect of the invention, the nozzles of the top head open at an incline to the conveyance direction of the sheet.

This configuration enables coating the edge areas at the ends of the sheet with solution.

A paper strengthener coating device according to another aspect of the invention preferably also has a conveyance device configured to convey the sheet; the inkjet head including a side head disposed at a side of the sheet conveyed by the conveyance device and having multiple nozzles; the side head ejecting the solution from the nozzles toward the edge part of the sheet as the sheet passes.

This configuration enables ejecting solution while conveying the sheet, and quickly applying the solution to edge areas of the sheet.

Preferably in a paper strengthener coating device according to another aspect of the invention, the paper strengthener coating unit has a solution transfer member configured to transfer the solution to and coat the sheet when in contact with the sheet.

This configuration enables applying solution to all of one side of the sheet.

A paper strengthener coating device according to another aspect of the invention preferably also has a controller configured to control operation of the inkjet head.

This configuration can quickly and accurately control operation of the inkjet head.

A paper strengthener coating device according to another aspect of the invention preferably also has a position detector configured to detect a position of the sheet relative to the inkjet head; the controller controlling the ejection timing for ejecting the solution from the nozzles based on the detection result of the position detector.

This configuration enables accurately applying solution to the target area of the sheet (such as an edge area) when the paper strengthener coating unit applies solution to the sheet.

Preferably in a paper strengthener coating device according to another aspect of the invention, the paper strengthener is a dry-strength additive.

A dry-strength additive is preferable as a paper strengthener, and can effectively suppress production of paper dust from the sheet.

Another aspect of the invention is a sheet manufacturing apparatus including a paper strengthener coating device according to the invention.

This configuration enables applying solution to the edge areas of the sheet where paper dust is easily produced. The solution can strengthen bonds between cellulose fibers contained in the sheet by means of a paper strengthener that is contained in the solution and penetrates the edge part of the sheet. As a result, production of paper dust by cellulose fibers separating from the sheet can be prevented.

Another aspect of the invention is a sheet characterized by the ratio X/Y between X and Y being greater than or equal to 1.1 and less than or equal to 100, where X is the content (%) of paper strengthener in an edge part of a paper sheet, and Y is the content (%) of paper strengthener in an inside area between the edge parts of the sheet.

In this aspect of the invention the edge areas of the sheet where paper dust is easily produced are sufficiently coated. The solution can strengthen bonds between cellulose fibers contained in the sheet by means of a paper strengthener that is contained in the solution and penetrates the edge part of the sheet. As a result, production of paper dust by cellulose fibers separating from the sheet can be prevented.

Another aspect of the invention is a sheet characterized by the ratio A/B between A and B being greater than or equal to 2, where A is the application area of paper strengthener in an edge part of a paper sheet, and B is the application area of paper strengthener in a transverse plane of an inside part between the edge parts of the sheet.

In this aspect of the invention the edge areas of the sheet where paper dust is easily produced are sufficiently coated. The solution can strengthen bonds between cellulose fibers contained in the sheet by means of a paper strengthener that is contained in the solution and penetrates the edge part of the sheet. As a result, production of paper dust by cellulose fibers separating from the sheet can be prevented.

Another aspect of the invention is a paper strengthener coating method including: a coating step of applying a solution including a paper strengthener to a paper sheet; the coating step using an inkjet head to preferentially or selectively apply the solution to an edge part of the sheet.

This configuration enables applying solution to the edge areas of the sheet where paper dust is easily produced. The solution can strengthen bonds between cellulose fibers contained in the sheet by means of a paper strengthener that is contained in the solution and penetrates the edge part of the sheet. As a result, production of paper dust by cellulose fibers separating from the sheet can be prevented.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view sequentially illustrating the operation of a paper strengthener coating device according to a first embodiment of the invention.

FIG. 2 is a plan view sequentially illustrating the operation of a paper strengthener coating device according to a first embodiment of the invention.

FIG. 3 is a plan view sequentially illustrating the operation of a paper strengthener coating device according to a first embodiment of the invention.

FIG. 4 is a plan view sequentially illustrating the operation of a paper strengthener coating device according to a first embodiment of the invention.

FIG. 5 is a plan view sequentially illustrating the operation of a paper strengthener coating device according to a first embodiment of the invention.

FIG. 6 is a plan view illustrating operation of the drying unit and compression unit located on the downstream side of a paper strengthener coating device according to a first embodiment of the invention.

FIG. 7 is a section view through A-A in FIG. 3.

FIG. 8 is a section view through B-B in FIG. 3.

FIG. 9 is a section view through C-C in FIG. 5.

FIG. 10 illustrates the arrangement of nozzles of the top head of the inkjet heads in a paper strengthener coating device according to a first embodiment of the invention.

FIG. 11 illustrates the arrangement of nozzles of the side heads of the inkjet heads in a paper strengthener coating device according to a first embodiment of the invention.

FIG. 12 is a vertical section view of the inkjet heads (top head and side heads) in a paper strengthener coating device according to a first embodiment of the invention.

FIG. 13 is a block diagram showing main parts of a paper strengthener coating device according to a first embodiment of the invention.

FIG. 14 is a flow chart of steps in the process (paper strengthener coating method of the invention) executed by the paper strengthener coating device of the invention.

FIG. 15 is a side section view of a sheet to which a paper dust suppression process was applied.

FIG. 16 is a view from arrow D in FIG. 15.

FIG. 17 is a section view through E-E in FIG. 15.

FIG. 18 is a plan view illustrating the operation of a paper strengthener coating device according to a second embodiment of the invention.

FIG. 19 is a plan view sequentially illustrating the operation of a paper strengthener coating device according to a third embodiment of the invention.

FIG. 20 is a plan view sequentially illustrating the operation of a paper strengthener coating device according to a third embodiment of the invention.

FIG. 21 is a partial side section view of the operation of a paper strengthener coating device according to a fourth embodiment of the invention.

FIG. 22 is a plan view sequentially illustrating the operation of a paper strengthener coating device according to a fifth embodiment of the invention.

FIG. 23 is a plan view sequentially illustrating the operation of a paper strengthener coating device according to a fifth embodiment of the invention.

FIG. 24 schematically illustrates the configuration of a sheet manufacturing apparatus according to a sixth embodiment of the invention.

FIG. 25 is a flow chart sequentially showing steps executed by the sheet manufacturing apparatus according to the sixth embodiment of the invention.

### DESCRIPTION OF EMBODIMENTS

Preferred embodiments of a paper strengthener coating device, sheet manufacturing apparatus, sheet, and paper strengthener coating method according to the present invention are described below with reference to the accompanying figures.

### Embodiment 1

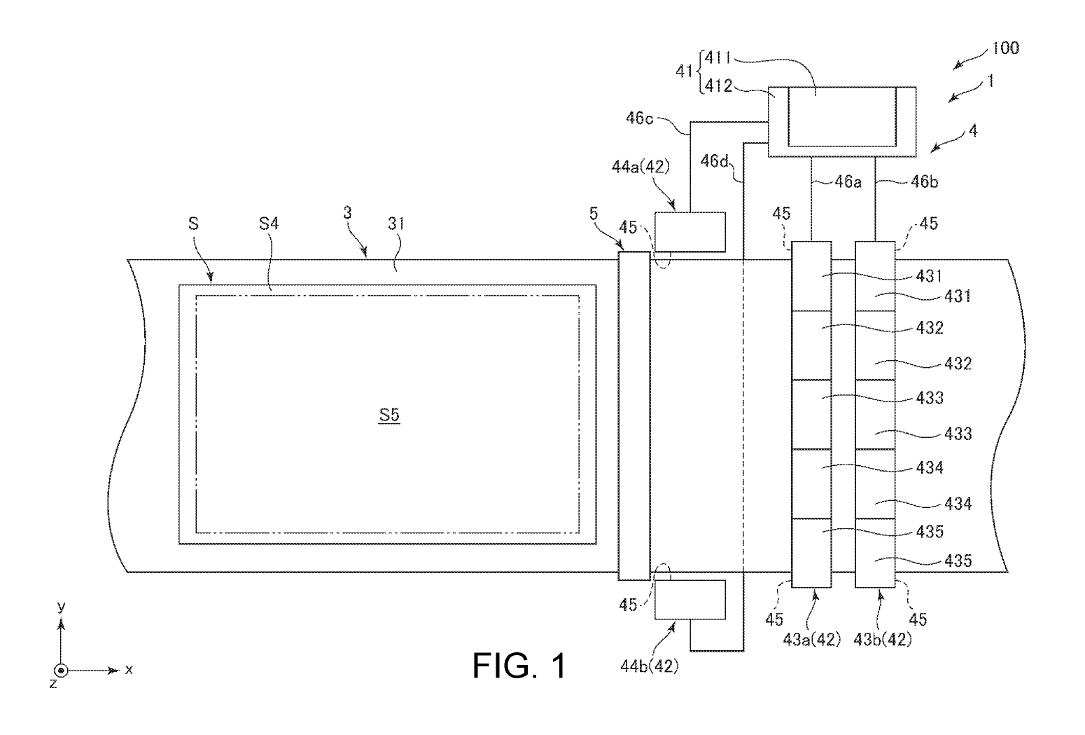

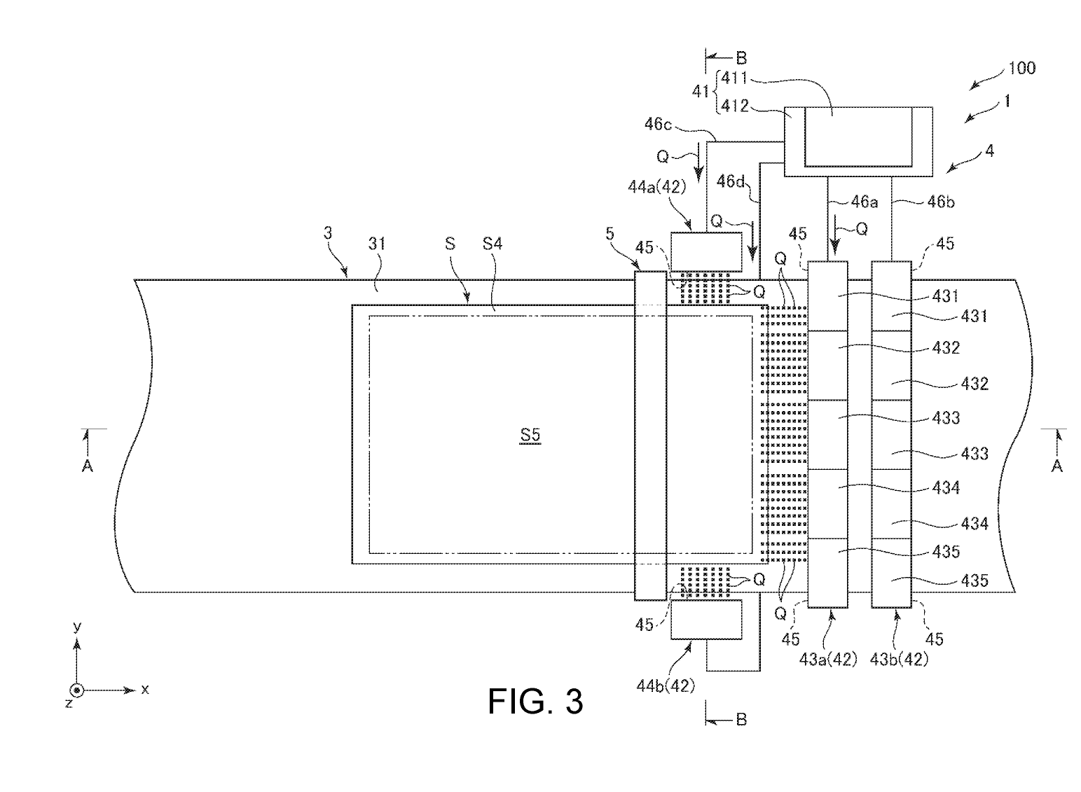

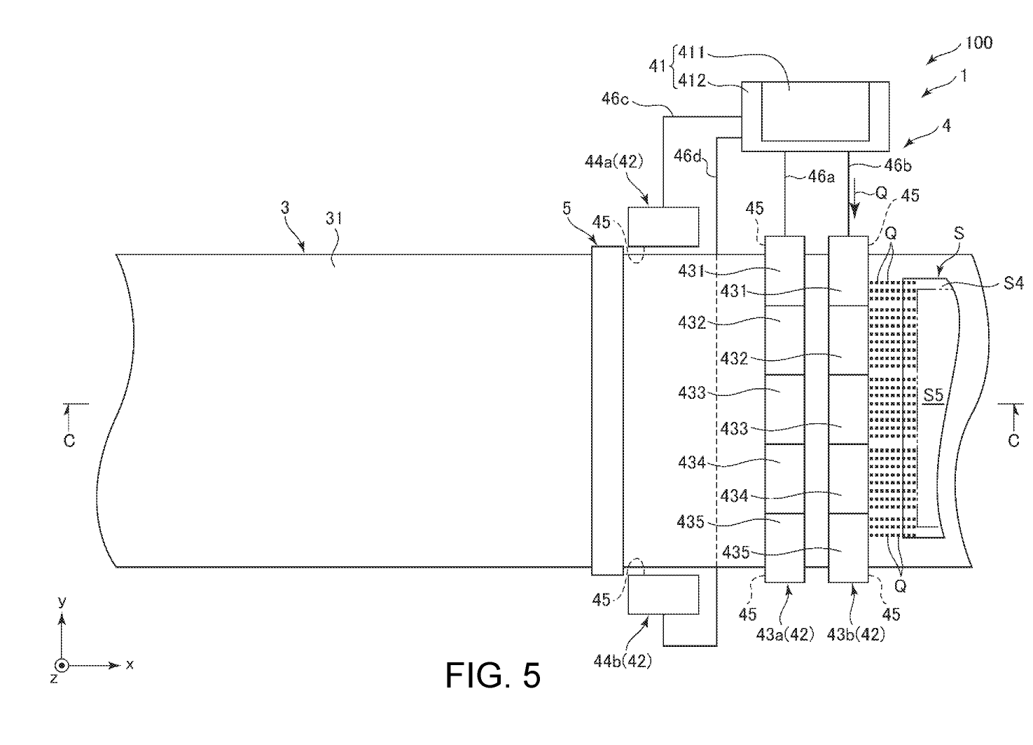

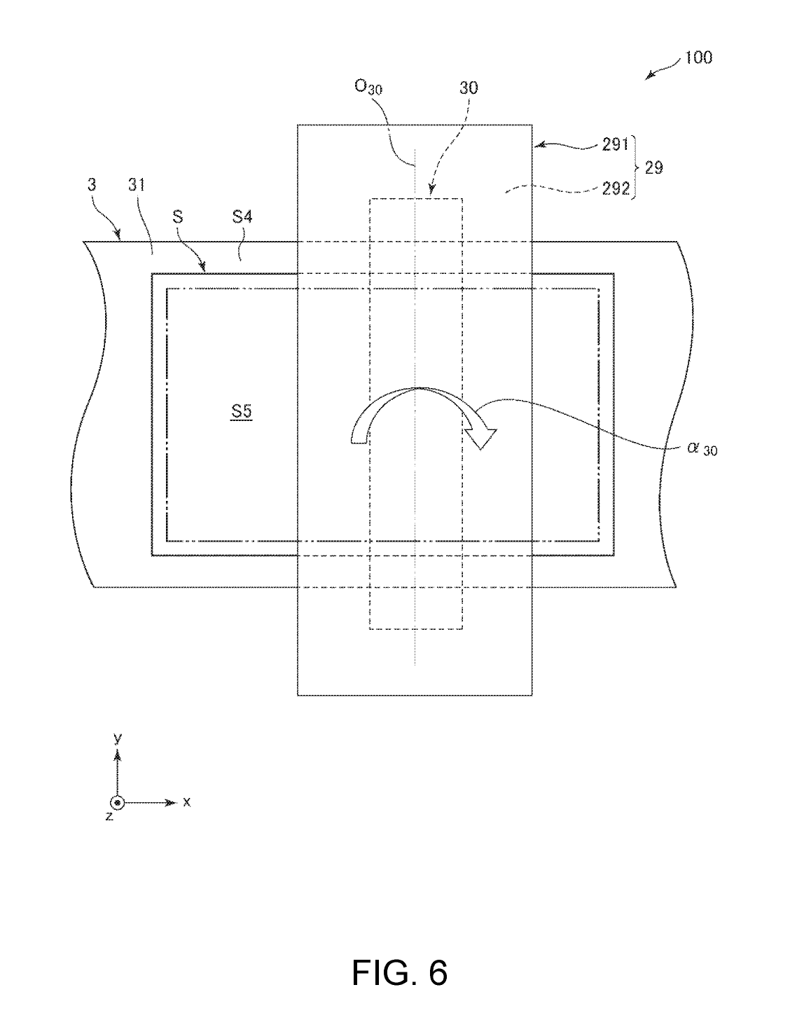

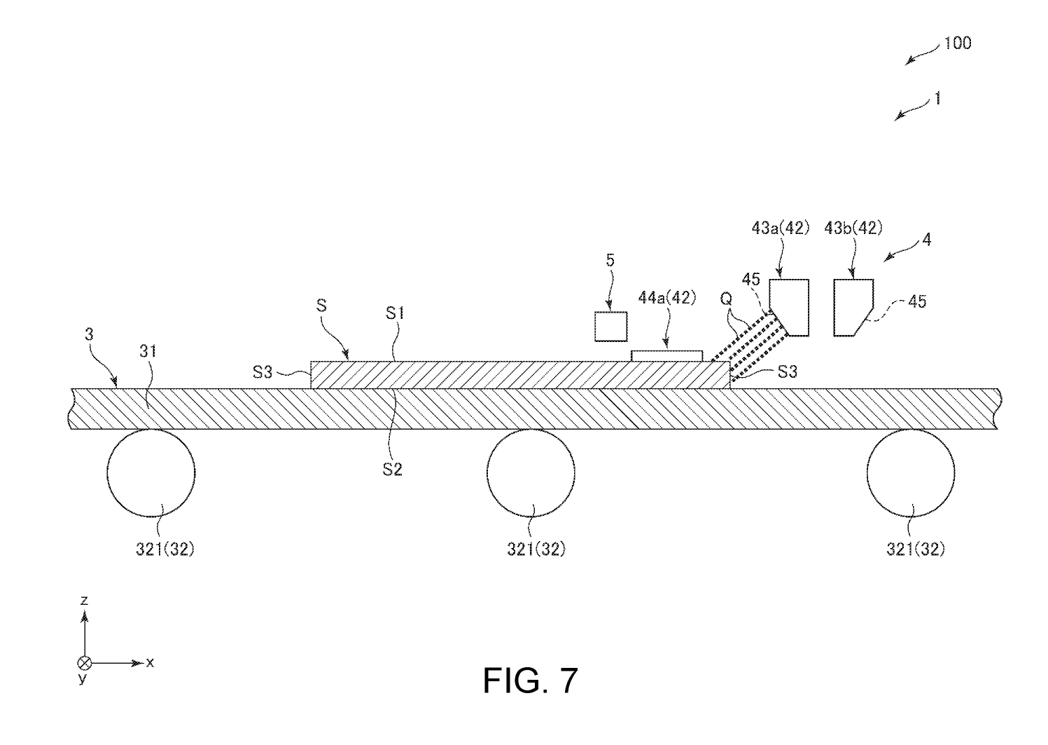

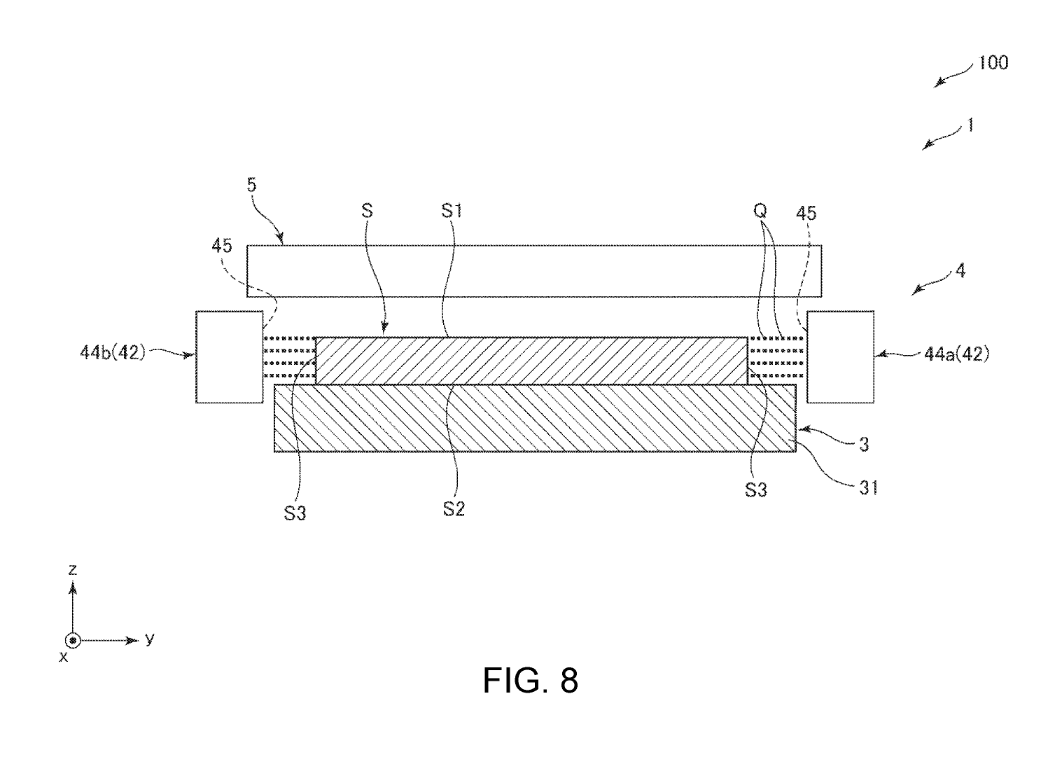

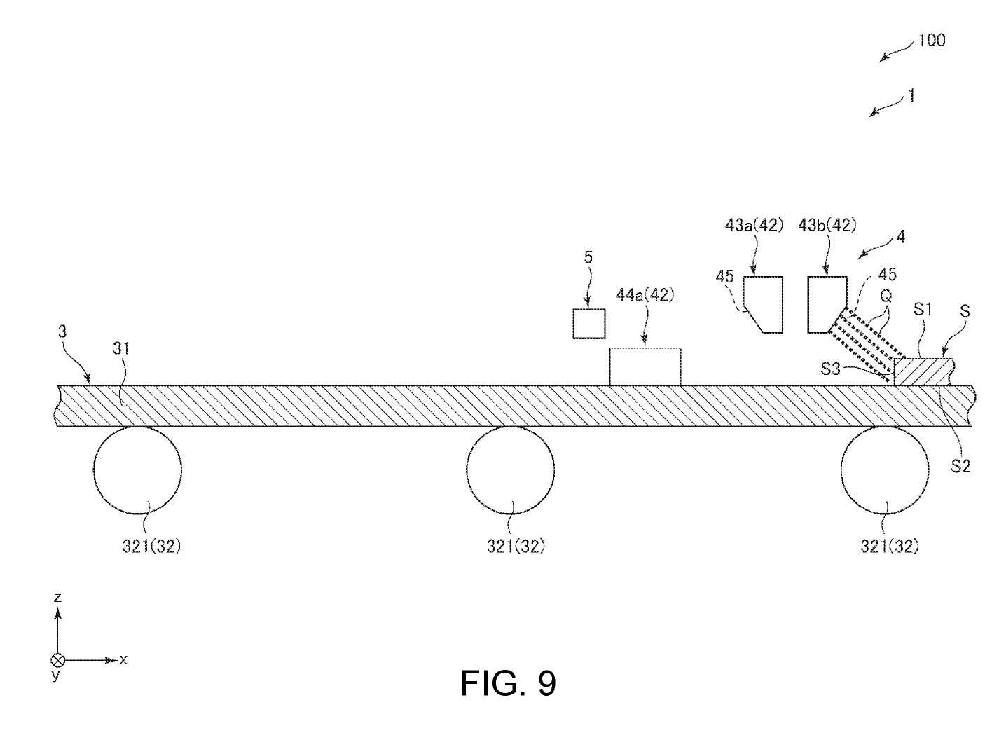

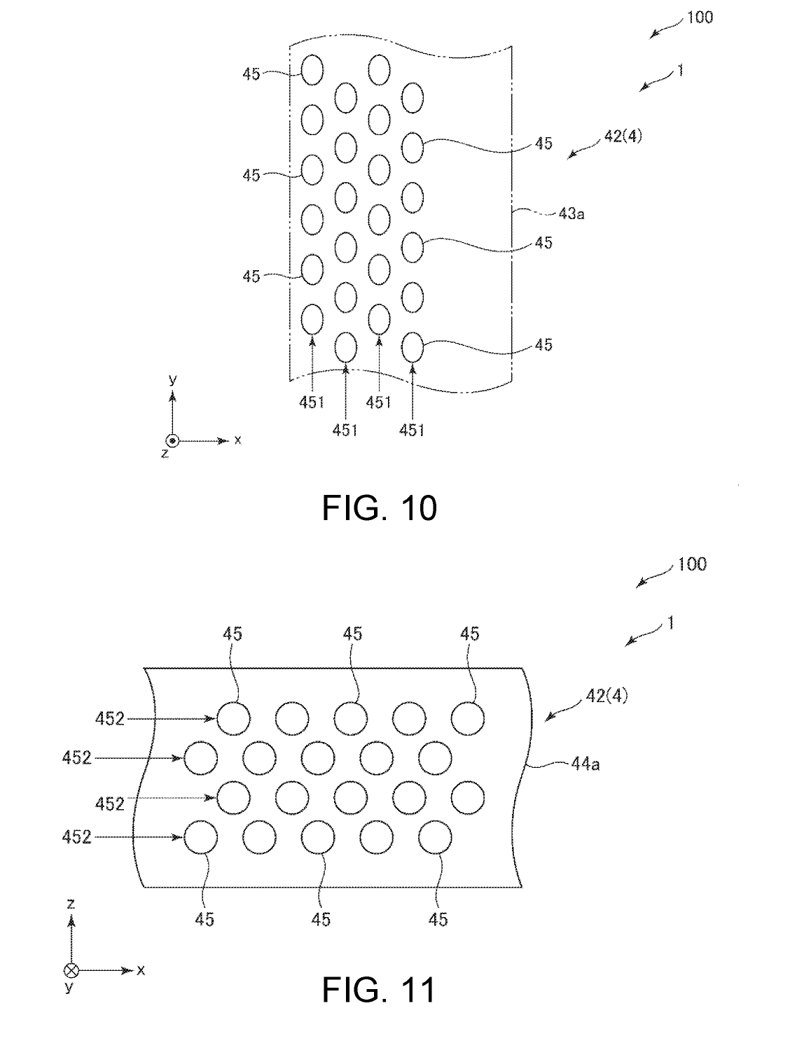

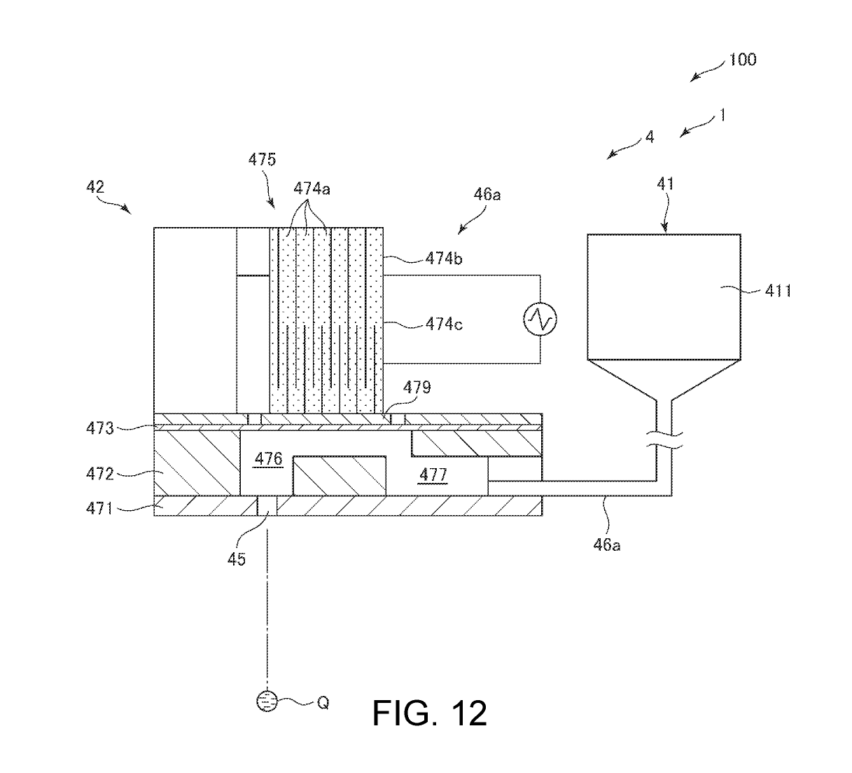

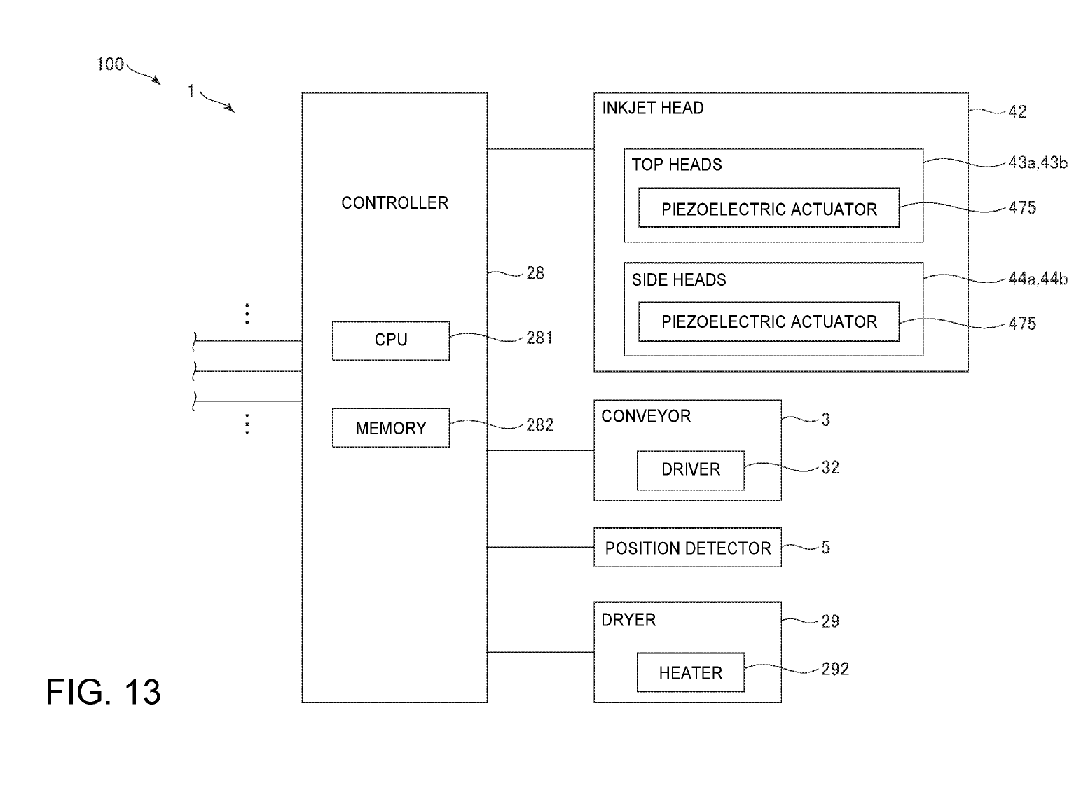

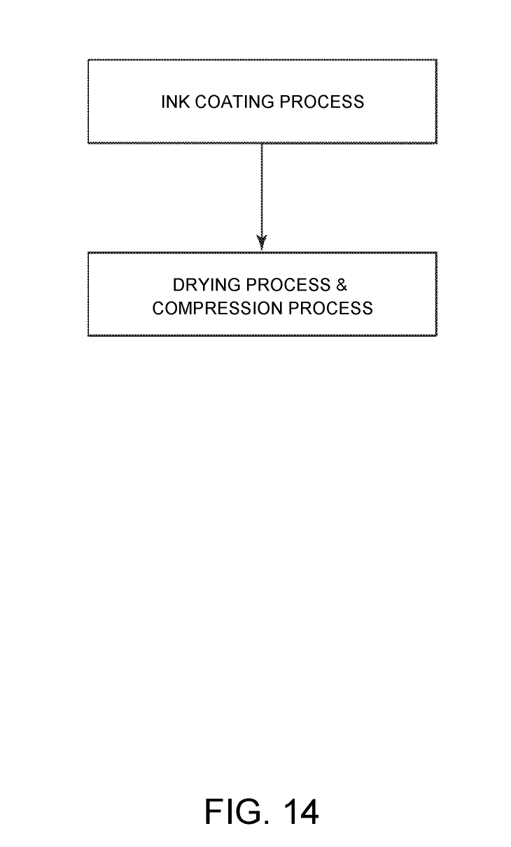

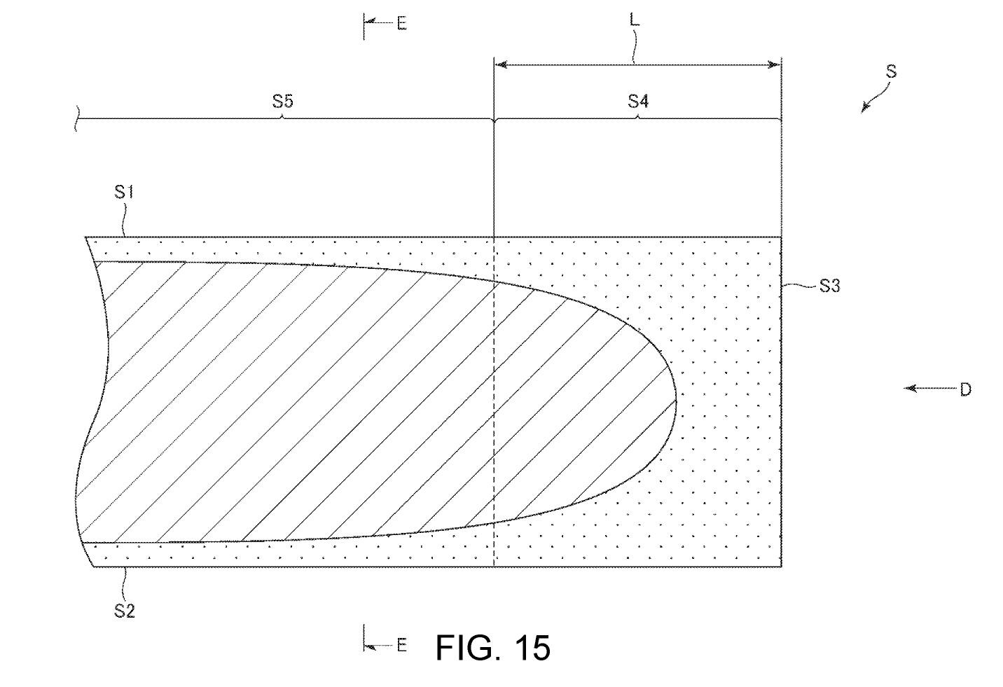

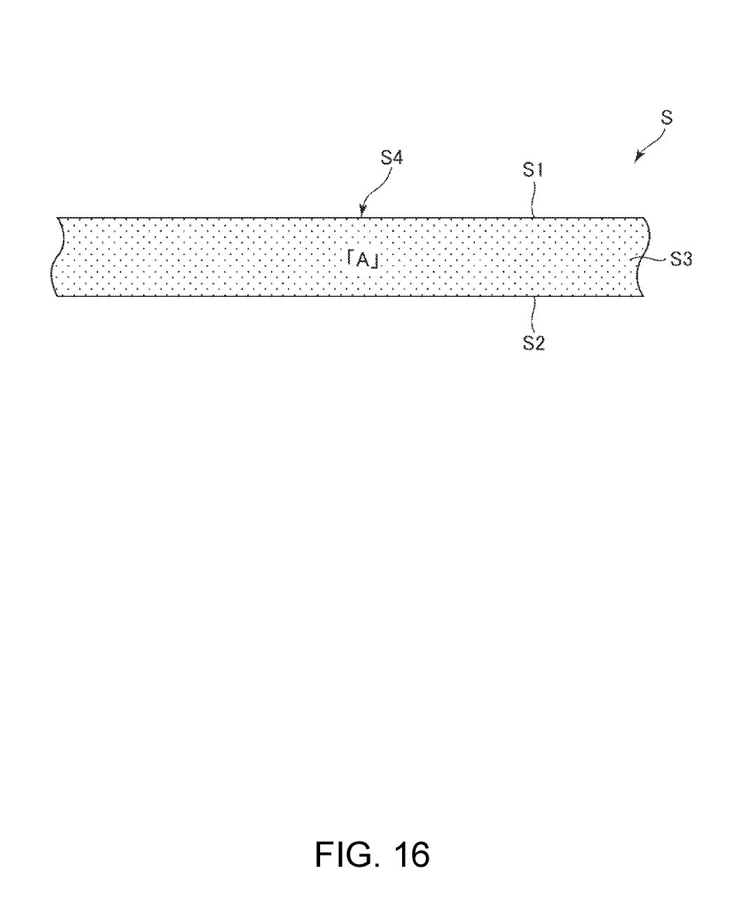

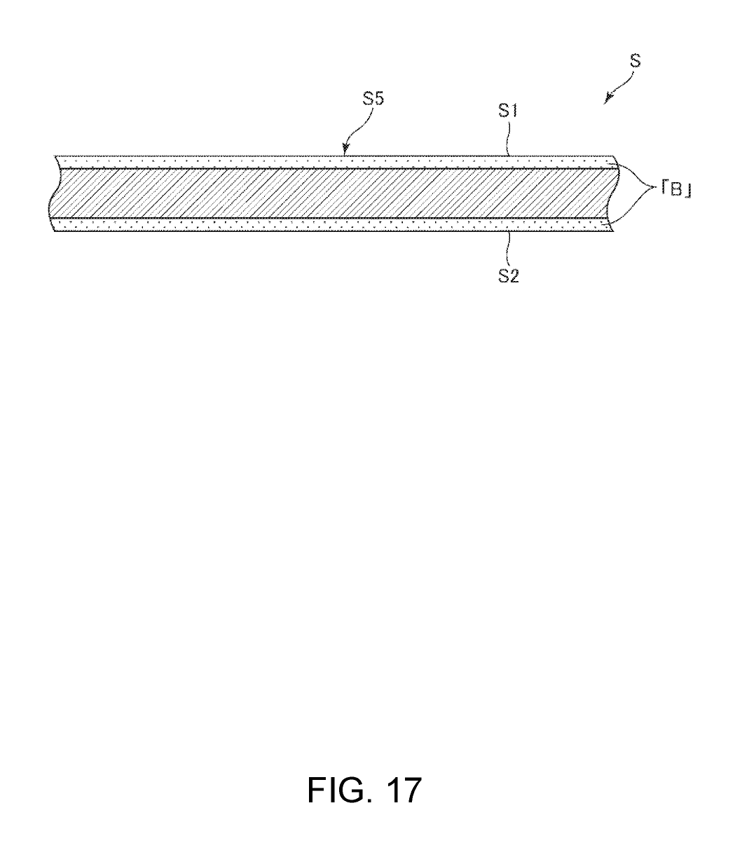

FIG. 1 to FIG. 5 are plan views sequentially illustrating the operation of a paper strengthener coating device according to a first embodiment of the invention. FIG. 6 is a plan view illustrating operation of the drying unit and compression unit located on the downstream side of a paper strengthener coating device according to a first embodiment of the invention. FIG. 7 is a section view through A-A in FIG. 3. FIG. 8 is a section view through B-B in FIG. 3. FIG. 9 is a section view through C-C in FIG. 5. FIG. 10 illustrates the arrangement of nozzles of the top head of the inkjet heads in a paper strengthener coating device according to a first embodiment of the invention. FIG. 11 illustrates the arrangement of nozzles of the side heads of the inkjet heads in a paper strengthener coating device according to a first embodiment of the invention. FIG. 12 is a vertical section view of the inkjet heads (top head and side heads) in a paper strengthener coating device according to a first embodiment of the invention. FIG. 13 is a block diagram showing main parts of a paper strengthener coating device according to a first embodiment of the invention. FIG. 14 is a flow chart of steps in the process (paper strengthener coating method of the invention) executed by the paper strengthener coating device of the invention. FIG. 15 is a side section view of a sheet to which a paper dust suppression process was applied. FIG. 16 is a view from arrow D in FIG. 15. FIG. 17 is a section view through E-E in FIG. 15.

Note that for convenience below, the direction from right to left in FIG. 1 is referred to as the X-axis, the direction from the top to the bottom axis in FIG. 1 is referred to as the Y-axis, and the direction perpendicular to the paper surface, that is, perpendicular to the X-axis and Y-axis, is referred to as the Z-axis. The coordinate axes in FIG. 1 and below correspond to the coordinate axes in FIG. 1. The direction indicated by the arrows on the coordinate axes is referred to as the positive direction, and the opposite direction as the negative direction.

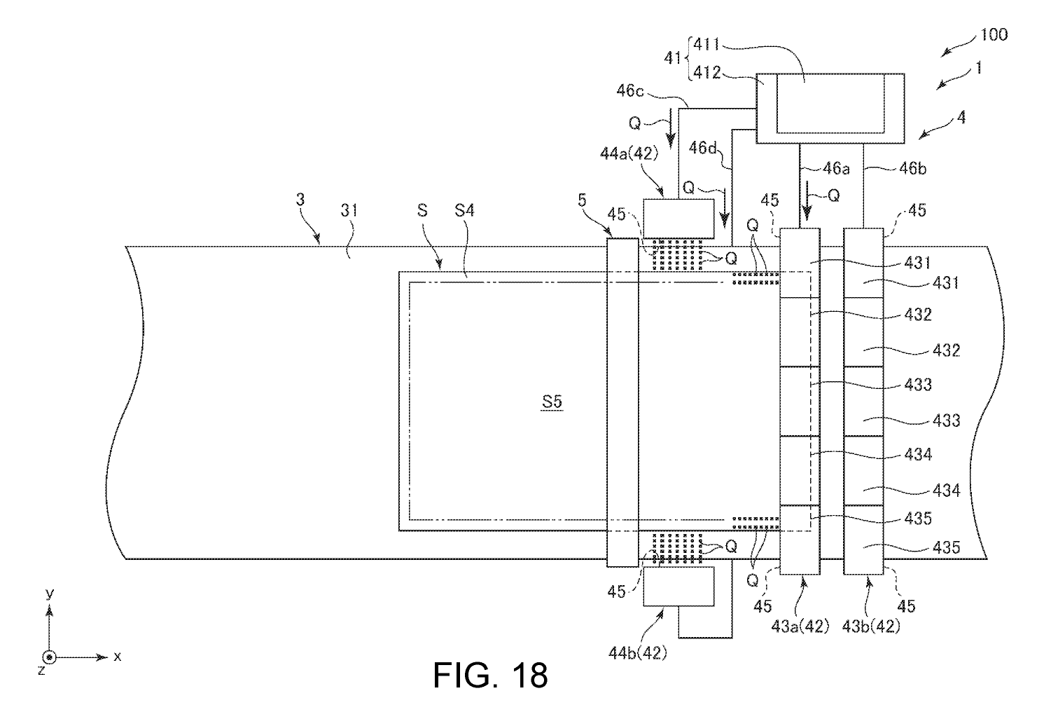

In addition, the left side in FIG. 1 to FIG. 7 and FIG. 9 (and in FIG. 18 to FIG. 24) is referred to as the left or upstream side, and the right side as the right or downstream side.

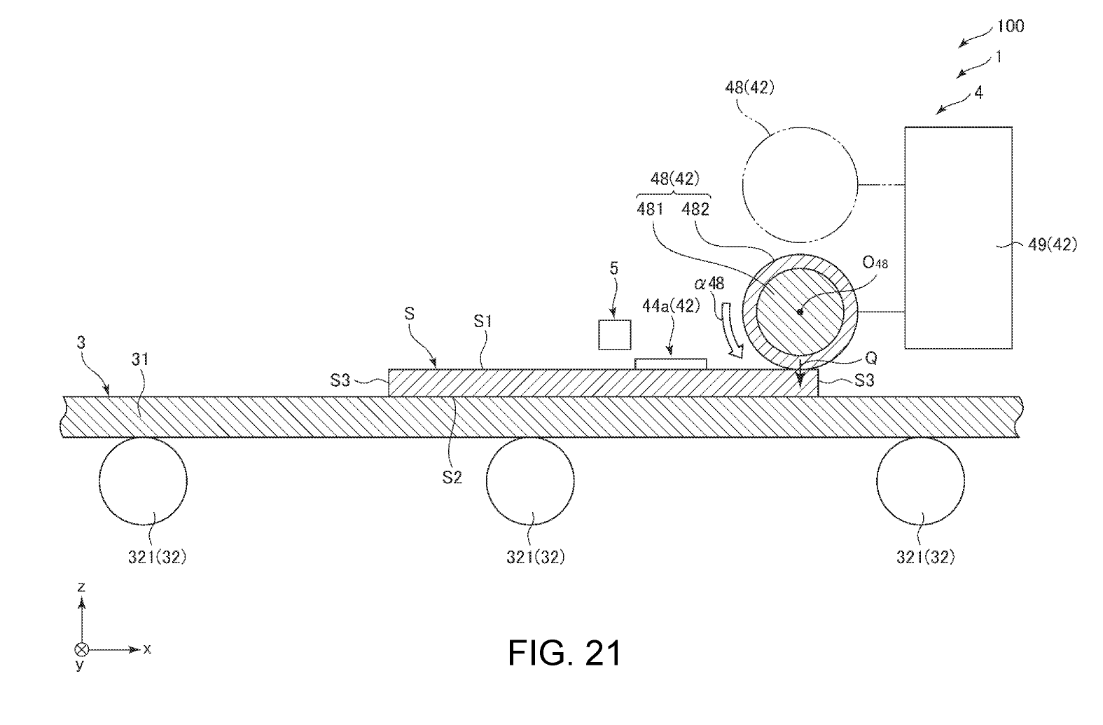

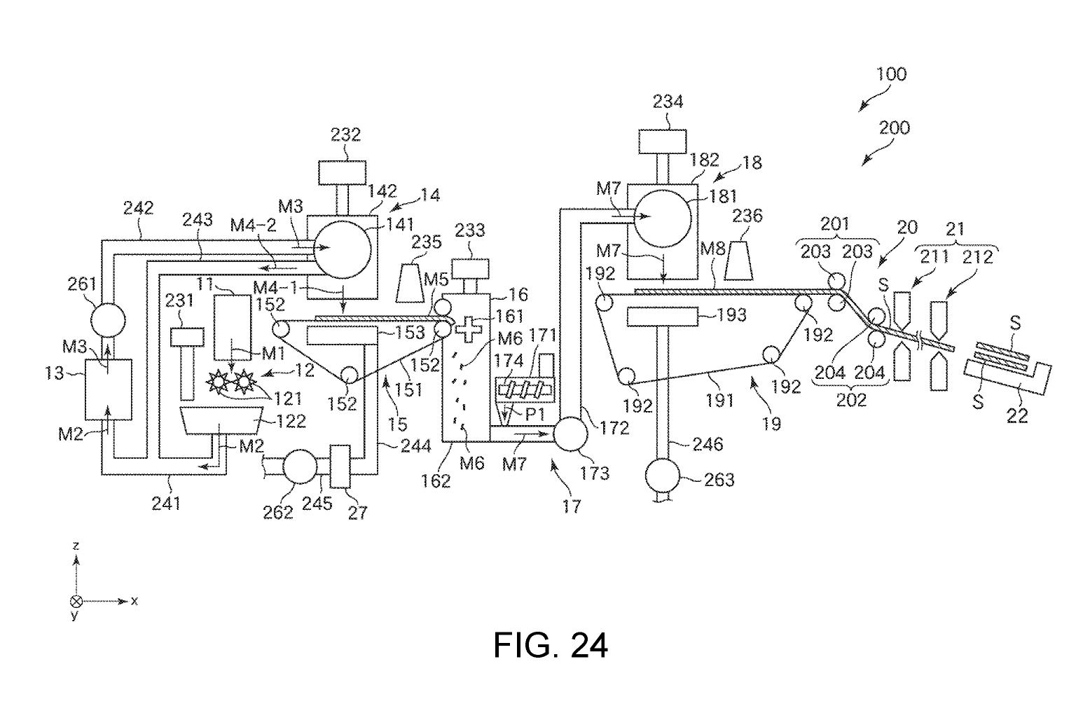

In addition, the side on the top in FIG. 7 to FIG. 9 and FIG. 15 to FIG. 17 (and in FIG. 21 and FIG. 24) is referred to as the top or above, and the on the bottom as the bottom or below.

In addition, in FIG. 7 to FIG. 9 (and in FIG. 21), the direction through the thickness of the sheet is exaggerated to facilitate understanding.

As shown in FIG. 1 to FIG. 5, a paper strengthener coating device 1 according to the invention has a paper strengthener coating unit 4 including an ink supply mechanism (solution supply mechanism) 41 that supplies a solution containing a paper strengthener (referred to below as ink Q), and an inkjet head 42 with nozzles 45 that eject the ink Q (solution) supplied from the ink supply mechanism (solution supply mechanism) 41, and coating a sheet S with ink Q (solution) supplied from the nozzles 45. The inkjet head 42 (solution ejection head) can preferentially or selectively coat the edge areas S4 of the sheet S with ink Q (solution).

The paper strengthener coating method of the invention includes a solution coating step (coating step) of coating a sheet S with ink Q (solution) including a paper strengthener, and in the solution coating step (coating step) uses the inkjet head 42 to preferentially or selectively coat the edge areas S4 of the sheet S with the ink Q (solution). This method is applied by the paper strengthener coating device 1.

As further described below, the invention thus comprised can coat the edge areas S4 of a sheet S where paper dust easily results with ink Q. The ink Q penetrates the edge areas S4, and the paper strengthener contained in the ink Q can strengthen the bonds between cellulose fibers contained in the sheet S (edge areas S4). This prevents production of paper dust from cellulose fibers separating from the sheet S.

This also prevents the production of paper dust, which can result in clogging the nozzles of the printhead, when printing color images on a sheet S using a printer such as an inkjet printer, for example. As a result, images can be consistently formed on sheets S. Image quality is also excellent because sufficient color ink can be ejected from the nozzles of the printer.

As shown in FIG. 1 to FIG. 5, a sheet manufacturing apparatus 100 according to the invention includes the paper strengthener coating device 1 according to the invention. As shown in FIG. 6, the sheet manufacturing apparatus 100 in this embodiment also has a dryer (drying means) 29, and a compression unit (compression means) 30. As shown in FIG. 14, the ink coating step, drying step, and compression step are executed sequentially by the sheet manufacturing apparatus 100. Note that the drying process and compression process execute simultaneously (at the same time) in this embodiment of the invention, but the invention is not so limited and may execute with a time difference therebetween.

With this aspect of the invention, a sheet S that can be used for inkjet printing, for example, can be produced with the benefits of the paper strengthener coating device 1 (paper strengthener coating method) described above.

Note that the sheet S before being coated with ink Q by the paper strengthener coating device 1 may be plain paper, for example. The plain paper may be recycled paper made by defibrating recovered paper, or it may be non-recycled paper. The shape of the sheet S in plan view is rectangular in this embodiment of the invention, but the invention is not so limited. When sheet S is rectangular, the size is also not specifically limited, and may be A4 size paper or a B series size paper.

As shown in FIG. 15, a sheet S has a top surface S1 facing up, a bottom surface S2 facing down, and edges S3 (cut edges) facing the sides. When the sheet S is rectangular in plan view, there are four edges S3. The edge areas S4 of a sheet S in this example are bands extending a distance L toward the center from the edges S3. The edge areas S4 of the sheet S are therefore the areas including the portions extending distance L from the edges S3 on the top surface S1, the portions extending distance L from the edges S3 on the edges S3, and the edges S3. The distance L may vary according to the size of the sheet S, but is preferably less than or equal to 0.1 mm and greater than or equal to 10 mm, and further preferably less than or equal to 1 mm and greater than or equal to 5 mm.

Below, the area on the inside of the sheet S from the edge areas S4 (the area indicated by the the dot-dot-dash lines in FIG. 1 to FIG. 6) is referred to as the inside area S5.

As shown in FIG. 1 to FIG. 5, the paper strengthener coating device 1 (also referred to below as simply coating device 1) has a conveyor 3 for conveying the sheet S, a paper strengthener coating unit 4 for applying ink Q to the sheet S, and a position detector 5 for detecting the position of the sheet S.

As shown in FIG. 13, the paper strengthener coating device (sheet manufacturing apparatus 100) has a controller 28 that controls operation of parts of the paper strengthener coating device 1 (such as the inkjet head 42, paper strengthener coating unit 4, and position detector 5).

The controller 28 has a CPU 281 (central processing unit) and memory 282. The CPU 281 makes decisions and issues commands, for example. The memory 282 stores programs, including programs controlling the sheet S manufacturing operation. The controller 28 may be incorporated in the paper strengthener coating device 1, or disposed to an external device such as an external computer.

The external device may communicate with the paper strengthener coating device 1 through a cable, wirelessly, or connect to the paper strengthener coating device 1 through a network (such as the Internet).

The CPU 281 and memory 282 may be integrated as a single unit, or the CPU 281 may be incorporated in the paper strengthener coating device 1 with the memory 282 disposed to an external device such as an external computer, or the memory 282 may be incorporated in the paper strengthener coating device 1 with the CPU 281 disposed to an external device such as an external computer.

The conveyor 3 includes a conveyor belt 31 configured by an endless belt, and a driver 32 that drives the conveyor belt 31.

The conveyor belt 31 supports the sheet S on the top surface of the conveyor belt 31. By operation of the driver 32, the conveyor belt 31 can then convey the sheet S in the positive direction (downstream) on the X-axis.

Note that the configuration of the conveyor belt 31 is not specifically limited, and a conveyor belt with a tacky surface coating may be used. When a tacky belt is used for the conveyor belt 31, the sheet S can be prevented from shifting or curling on the conveyor belt 31 while the sheet S is conveyed. As a result, when the paper strengthener coating unit 4 applies ink Q to the sheet S, the ink Q can be accurately applied to the target area (such as the edge areas S4) of the sheet S.

The driver 32 includes multiple rollers 321 and a motor (not shown in the figure) used as the drive source connected to at least one of the rollers 321. The rollers 321 turn in conjunction with operation of the driver 32, and the conveyor belt 31 can convey the sheet S at a specific speed. Operation of the driver 32 is controlled by the controller 28 (see FIG. 13), and the conveyance speed of the conveyor belt 31 can be varied (set to multiple levels). Note that the motor and rollers 321 are preferably connected through a transmission.

The conveyor 3 in this example is configured with a conveyor belt 31, but the invention is not so limited and may be a flat member, such as a platen, that supports and holds the sheet S by suction.

When images are formed by color printing by a printer such as an inkjet printer on an unused sheet S, paper dust may be produced from the sheet S (particularly the edges S3). This paper dust results from cellulose fibers that have separated from the sheet S, for example. The paper dust can disperse inside the printer while printing on the sheet S, and can be a cause of clogging the nozzles of the printer. When the nozzles become clogged, color ink cannot be sufficiently ejected from the nozzles, adversely affecting the quality of the images printed on the sheet S.

The coating device 1 of the invention is therefore configured to apply a paper dust suppression process to the sheet S to prevent production of paper dust. The configuration and operation of the paper dust suppression process are described below.

The paper strengthener coating unit 4 (referred to below as simply coating unit 4) is the section that applies an ink coating step (coating step) of applying ink Q to the sheet S. The coating unit 4 includes an ink supply unit 41 that supplies the ink Q, and an inkjet head 42 that ejects the ink Q supplied from the ink supply unit 41.

As shown in FIG. 1 to FIG. 5, the ink supply unit 41 includes a tank 411 that stores the ink Q, and a loading unit 412 in which the tank 411 is installed.

When the ink Q runs out, the tank 411 can be replaced with another tank 411 sufficiently charged with ink Q.

The ink Q stored in this tank 411 includes a paper strengthener.

The ink Q may be an aqueous ink, solvent ink, UV-cure ink, or latex ink, for example.

An aqueous ink is an ink having a binder resin dissolved in an aqueous solvent.

A solvent ink is an ink having a binder resin dissolved in a chemical solvent.

A UV-cure ink is an ink having a binder resin dissolved in a liquid monomer that cures when exposed to UV light.

A latex ink is an ink having a binder resin dispersed in a dispersant.

A paper strengthener is a type of paper chemical used to increase the strength of the sheet S (paper). Examples of a paper strengthener include dry-strength additives and wet-strength additives, and of these, dry-strength additives are preferable. A dry-strength additive is therefore desirable as the paper strengthener. A dry-strength additive increases the strength of the sheet S when in a dry state, and is suited to the actual state of the sheet S when used (when printing on the sheet S).

Examples of dry-strength additives include cationic starch, amphoteric starch, amphoteric polyacrylamide (PAM), and carboxymethyl cellulose (CMC). Of these, carboxymethyl cellulose (CMC) is preferable. The molecular weight of the carboxymethyl cellulose is not specifically limited, and is preferably less than or equal to 100,000, and further preferably greater than or equal to 15,000 and less than or equal to 70,000.

Examples of wet-strength additives include epichlorohydrin resins such as polyamide-epichlorohydrin resin, urea formaldehyde resin (UF), acid colloid-melamine resin, and thermally crosslinked polyacrylamide (PAM) (thermally crosslinked PAM).

The binder resin is not limited to the following, but may be a homopolymer or copolymer of styrene-butadiene, urethane, (meth)acrylic acid, (meth)acrylic acid ester, acrylonitrile, cyanoacrylate, acrylamide, olefin, styrene, vinyl acetate, vinyl chloride, vinyl alcohol, vinyl ether, vinylpyrrolidone, vinylpyridine, vinylcarbazole, vinylimidazole, vinylidene chloride; a fluorocarbon polymer, or a natural resin. Of these, styrene-butadiene resin or urethane resin is preferable. Copolymers may be in the form of a random copolymer, block copolymer, alternating copolymer, or graft macromolecule.

The tank 411 is installed to the loading unit 412. The loading unit 412 positions the tank 411, and can stably supply ink Q to the inkjet head 42.

As shown in FIG. 1 to FIG. 5, the inkjet head 42 includes a top head 43a (first top head), top head 43b (second top head), side head 44a (first side head), and side head 44b (second side head). The top head 43a, top head 43b, side head 44a, and side head 44b each have numerous nozzles 45 (see FIG. 10, FIG. 11) for ejecting 11 supplied from the ink supply unit 41 to the sheet S.

The top head 43a is connected by a fluid-tight connection to the tank 411 through a conduit 46a. As a result, ink Q is supplied from the tank 411 to the top head 43a.

The top head 43b is connected by a fluid-tight connection to the tank 411 through a conduit 46b. As a result, ink Q is supplied from the tank 411 to the top head 43b.

The side head 44a is connected by a fluid-tight connection to the tank 411 through a conduit 46c. As a result, ink Q is supplied from the tank 411 to the side head 44a.

The side head 44b is connected by a fluid-tight connection to the tank 411 through a conduit 46d. As a result, ink Q is supplied from the tank 411 to the side head 44b.

In this embodiment of the invention, side head 44a and side head 44b are disposed on the upstream in the conveyance direction of the sheet S, and top head 43a and top head 43b are disposed on the downstream side, but the invention is not so limited and top head 43a and top head 43b may disposed on the upstream side in the conveyance direction of the sheet S and the side head 44a and side head 44b on the downstream side.

In addition, top head 43a, top head 43b, side head 44a, and side head 44b are all inkjet heads, and configured to eject ink Q as ink droplets. This configuration is described used top head 43a as an example.

As shown in FIG. 12, the top head 43a includes a nozzle plate 471, cavity substrate 472, vibrator 473, and a piezoelectric actuator 475 stack comprising multiple piezoelectric elements 474a. Nozzles 45 are formed through the nozzle plate 471.

A cavity (pressure chamber) 476 and reservoir 477 communicating with the cavity 476 are formed inside the cavity substrate 472. The cavity 476 is filled with ink Q, and the internal pressure of the cavity 476 increases and decreases with the vibration of the vibrator 473. The nozzles 45 communicate with the cavity 476. The ink Q can be ejected as droplets by the increase and decrease in the internal pressure of the cavity 476. In addition, the reservoir 477 connects through a tube 46a to the ink supply unit 41 (tank 411).

The piezoelectric actuator 475 causes the vibrator 473 to vibrate. The piezoelectric actuator 475 comprises first electrodes 474b and opposing second electrodes 474c in a comblike configuration, and piezoelectric elements 474a alternately disposed to the tines of the first electrodes 474b and second electrodes 474c. One end of the piezoelectric actuator 475 is bonded to the vibrator 473 through an intermediate layer 479.

The piezoelectric actuator 475 thus comprised is electrically connected to the controller 28 (see FIG. 13). The piezoelectric actuator 475 operates in a mode of expanding and contracting vertically as seen in FIG. 12 in response to a drive signal from the controller 28 (drive signal source) applied between the first electrodes 474b and second electrodes 474c. Because the piezoelectric elements 474a are in a stacked arrangement, a relatively strong drive force can be achieved by the piezoelectric actuator 475. When the drive signal is applied to the piezoelectric actuator 475, vibration is produced in the vibrator 473. As a result, the pressure inside the cavity 476 changes, and drops of ink Q are ejected from the nozzles 45. The volume of ink Q ejected from the nozzles 45 can also be adjusted by varying the strength of the drive signal. In this way, the piezoelectric actuator 475 also functions as an adjustment unit that adjusts the amount of ink Q ejected from the nozzles 45.

As described above, the paper strengthener coating device 1 also has a conveyor 3 for conveying the sheet S. The inkjet head 42 is disposed above, that is, on the positive direction side on the Z-axis, the sheet S conveyed by the conveyor 3, and includes a top head 43a and top head 43b having multiple nozzles 45 extending transversely (in this embodiment, on the Y-axis perpendicular to the X-axis) to the conveyance direction (X-axis) of the sheet S.

As shown in FIG. 1 to FIG. 5, FIG. 7, and FIG. 9, top head 43a is disposed to a fixed position above and crosswise to the longitudinal direction of the conveyor belt 31 of the conveyor 3. Top head 43b is also disposed to a fixed position above and crosswise to the longitudinal direction of the conveyor belt 31 of the conveyor 3. In this embodiment, the top head 43b is on the downstream side of the top head 43a.

As shown in FIG. 7, the top head 43a is configured with the nozzles 45 inclined to the conveyance direction of the sheet S and opening to the left in the configuration shown in FIG. 7. As shown in FIG. 9, the top head 43b is configured with the nozzles 45 inclined to the conveyance direction of the sheet S in the opposite direction as the nozzles 45 of the top head 43a, and opening to the right in the configuration shown in FIG. 9.

The top head 43a and top head 43b are configured identically except for their positions and the direction in which the nozzles 45 open, and are therefore described below with reference to top head 43a.

As shown in FIG. 10, top head 43a has multiple nozzles 45. The nozzles 45 are disposed at an equal interval along the Y-axis, forming a nozzle row 451.

There are also multiple nozzle rows 451. The multiple nozzle rows 451 are disposed at an equal interval along the X-axis. The nozzle rows 451 adjacent to each other on the X-axis are offset from each other the distance of half the pitch between the nozzles 45 adjacent to each other on the Y-axis.

Note that the nozzle rows 451 are formed extending on the Y-axis perpendicular to the the conveyance direction of the sheet S (X-axis), but the invention is not so limited and the nozzle row 451 may be formed diagonally to the X-axis.

The number of nozzles 45 formed along the Y-axis is sufficient to ensure that ink Q can be ejected to the sheet S regardless of the width (length on the Y-axis) of the sheet S.

The top heads 43a with the nozzles 45 thus arranged are segmented into multiple units (five units in this embodiment) along the Y-axis as shown in FIG. 1 to FIG. 5. These units are referred to sequentially from the positive side on the Y-axis as the first unit 431, second unit 432, third unit 433, fourth unit 434, and fifth unit 435.

As shown in FIG. 3 (FIG. 7), the top head 43a can eject ink Q (solution) from the nozzles of the first unit 431 to fifth unit 435 to the edge areas S4 of the sheet S from the front (downstream side) in the conveyance direction as the sheet S passes. As a result, ink Q is applied to the part on the top surface S1 side and the front (leading) edge S3 in the conveyance direction.

Note that, as described below, the ejection timing of the ink Q from the top head 43a is controlled by the controller 28 based on the detection result from the position detector 5.

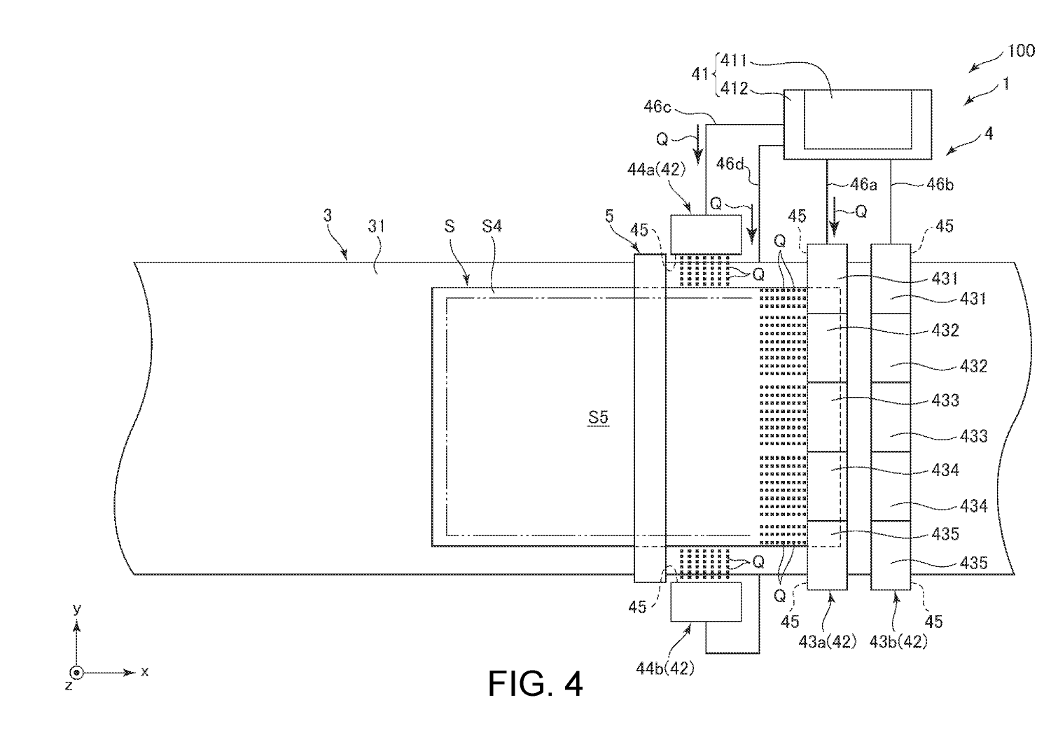

As as shown in FIG. 4, the top head 43a can also eject ink Q (solution) from the nozzles of the second unit 432 to fourth unit 434 to the inside area S5 of the sheet S as the sheet S passes. The multiple nozzles 45 of the top head 43a include inside nozzles (the nozzles 45 of second unit 432 to fourth unit 434) facing the inside area S5 between the side edge areas S4 of the sheet S when the sheet S passes, and ink Q can be ejected from these inside nozzles to the inside area S5. As a result, ink Q is applied to the inside area S5 of the sheet S on the top surface S1, and production of paper dust from this area can therefore be prevented.

Depending upon the size of the sheet S, ink Q may also be ejected to the inside area S5 of the sheet S from some nozzles of the first unit 431 or fifth unit 435.

As described above, the piezoelectric actuator 475 also functions as an adjustment unit for adjusting the amount of ink Q ejected from the nozzles 45. As a result, the top head 43a has an an adjustment unit for adjusting the amount of ink Q (solution) ejected to the edge areas S4 of the sheet S, and the amount of ink Q (solution) ejected to the inside area S5. As a result, the amount of ink Q ejected to the edge areas S4 of the sheet S can be greater than the amount of ink Q ejected to the inside area S5. The top head 43a (inkjet head 42) are thus configured to prioritize applying ink Q to the edge areas S4 over the inside area S5 of the sheet S.

From experience we know that paper dust from a sheet S is produced more easily from the edge areas S4 than the inside area S5. By prioritizing applying ink Q to the edge areas S4, the ink Q can permeate the edge areas S4, and the paper strengthener in the ink Q can strengthen the bonds between cellulose fibers contained in the sheet S (edge areas S4). As a result, production of paper dust from cellulose fibers separating from the sheet S can be prevented.

For example, when printing color images on a sheet S using a printer such as an inkjet printer, images can be consistently formed on sheets S while preventing the production of paper dust that can result in clogging the nozzles of the printhead. Image quality is also excellent because sufficient color ink can be ejected from the nozzles of the printer to form images.

There is also no need to provide the printer with configurations for removing or collecting paper dust, and the size of the printer can be reduced accordingly.

As shown in FIG. 5 (FIG. 9), top head 43b can eject ink Q from the nozzles of the first unit 431 to fifth unit 435 to the edge areas S4 of the sheet S from the trailing end (upstream side) in the conveyance direction as the sheet S passes. As a result, ink Q is applied to the part on the top surface S1 side and the back (trailing) edge S3 in the conveyance direction.

As described above, the paper strengthener coating device 1 has a conveyor 3 for conveying sheets S. The inkjet head 42 also includes side head 44a and side head 44b that have multiple nozzles 45 and are disposed along the sides of the sheet S conveyed by the conveyor 3.

As shown in FIG. 1 to FIG. 5, side head 44a is disposed on the top side of the conveyor belt 31 as seen in the figures, that is, on the positive side on the Y-axis. The open ends of the nozzles 45 of the side head 44a face the conveyor belt 31, that is, the negative side on the Y-axis.

Side head 44b is disposed on the bottom side of the conveyor belt 31 as seen in the figures, that is, on the negative side on the Y-axis. The open ends of the nozzles 45 of the side head 44b face the conveyor belt 31, that is, the positive side on the Y-axis.

The side head 44a and side head 44b are configured identically except for their positions and the direction in which the nozzles 45 open, and are therefore described below with reference to side head 44a.

As shown in FIG. 11, side head 44a has multiple nozzles 45. The nozzles 45 are disposed at an equal interval along the X-axis, forming a nozzle row 452.

There are also multiple nozzle rows 452. The multiple nozzle rows 452 are disposed at an equal interval along the Z-axis. The nozzle rows 452 adjacent to each other on the Z-axis are offset from each other the distance of half the pitch between the nozzles 45 adjacent to each other on the X-axis.

As shown in FIG. 3 (FIG. 8) and FIG. 4, side head 44a can eject ink Q (solution) from the nozzles to the edge areas S4 of the sheet S from the side of the sheet S as the sheet S passes. As a result, ink Q is applied to the edge S3 of the edge area S4 of the sheet S facing the side head 44a. The side head 44a (inkjet head 42) is thus configured to selectively coat the edge area S4 of the sheet S with ink Q.

As described below, the ejection timing of the ink Q from the side head 44a is controlled by the controller 28 based on the detection result from the position detector 5.

A inkjet head 42 configured as described above can thus apply ink Q to a first side (surface) of the sheet S. After applying ink Q, the sheet S can be reversed to coat the second (other) side of the sheet S with the inkjet head 42.

The position detector 5 detects the position of the sheet S relative to the inkjet head 42. The position detector 5 is disposed to a fixed position above and crosswise to the longitudinal direction of the conveyor belt 31 of the conveyor 3. The position detector 5 is also on the upstream side of the inkjet head 42 (side head 44a and side head 44b).

In this embodiment, the position detector 5 is a reflective line sensor having an emitter that emits light and a photodetector that receives the reflection of the light emitted by the emitter. Based on the amount of light received by the photodetector, the current position of the sheet S on the conveyor belt 31 can be detected. In addition, as shown in FIG. 13, the position detector 5 is electrically connected to the controller 28. The detection result of the position detector 5 is sent to the controller 28. The controller 28 can then control control the ejection timing of the ink Q from the nozzles 45 based on the detection result.

The position detector 5 is a reflective line sensor in this embodiment of the invention, but the invention is not so limited, and the position detector 5 may be a transmissive line sensor having an emitter that emits light and a photodetector that receives the light transmitted from the emitter.

As shown in FIG. 6, the sheet manufacturing apparatus 100 has a dryer 29 (drying device) and compression unit 30 (compression device).

The dryer 29 applies a drying process to dry the ink Q in the sheet S after the ink Q is applied. The dryer 29 is located downstream from the inkjet head 42, and comprises a chamber 291 and a heater 292 inside the chamber 291.

The sheet S being conveyed can pass through the inside of the chamber 291.

The heater 292 heats the sheet S as it passes through the chamber 291, causing the liquid portion of the ink Q to evaporate. As a result, the ink Q can be dried. As shown in FIG. 13, the heater 292 is electrically connected to the controller 28. As a result, voltage can be applied to the heater 292 to operate the heater 292. Note that the voltage applied to the heater 292 is controlled by the controller 28.

The controller 28 is also electrically connected to the driver 32 of the conveyor 3. As a result, the conveyance speed of the sheet S, that is, the time from when the sheet S enters the chamber 291 to when it leaves the chamber 291, can be controlled. By appropriately controlling the conveyance speed (time in the heater 292) and the heating temperature of the heater 292, the drying condition of the ink Q can be changed.

The compression unit 30 applies a compression process that compresses the sheet S as the sheet S is dried. The compression unit 30 is disposed above the conveyor belt 31, and in this example is an idler roller supported rotatably inside the chamber 291. The compression unit 30 in this example is a calender that turns in the direction of arrow α₃₀ on an axis of rotation O₃₀, pressing the sheet S against the conveyor belt 31 between the compression unit 30 and the rollers 321.

Bypassing through the drying process and compression process, wrinkles, waves, curling, and other unintentional deformations of the sheet S are removed, making the sheet S suitable for printing.

The operation of the sheet manufacturing apparatus 100, that is, the process acquiring a sheet S that has past the paper dust suppression process of applying ink Q to a sheet S by the paper strengthener coating device 1, and then drying the sheet S by the dryer 29 and calendering the sheet S by the compression unit 30, is described next with reference to FIG. 1 to FIG. 6. As described above, the controller 28 controls the operation of parts of the sheet manufacturing apparatus 100.

First, as shown in FIG. 1, the sheet S is conveyed by the conveyor 3 to before the position detector 5.

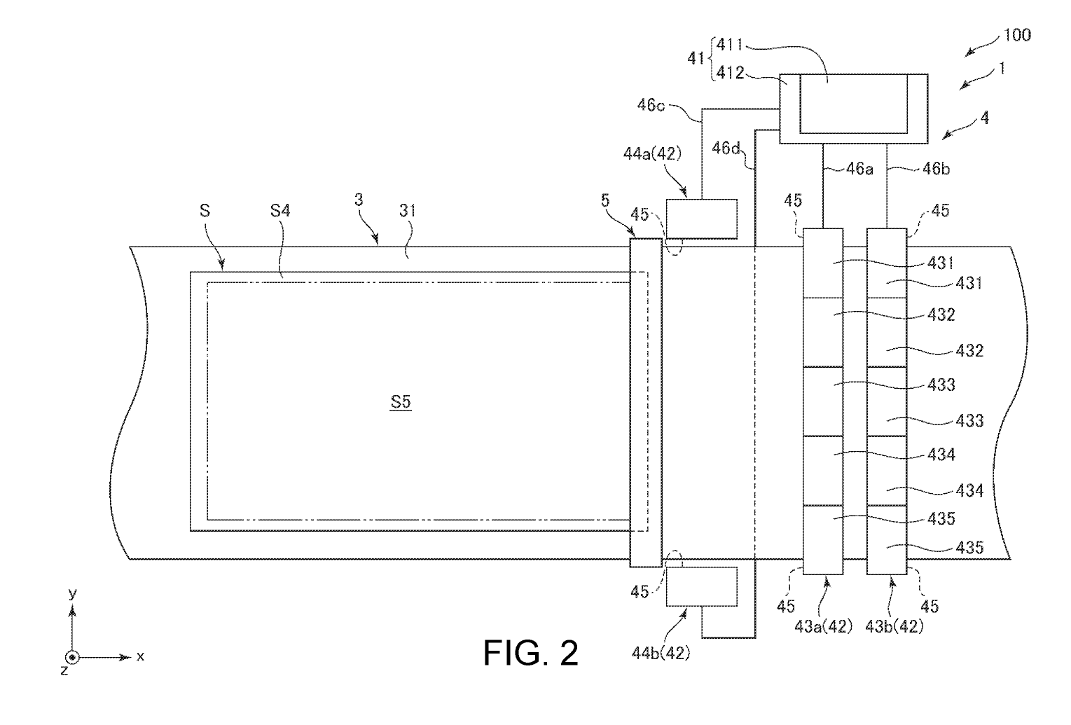

Next, as shown in FIG. 2, the sheet S begins passing below the position detector 5. The position detector 5 then detects the part of the edge areas S4 of the sheet S at the leading end in the conveyance direction. When a first specific time has past after the leading end is detected, the side head 44a and side head 44b starting ejecting ink Q. Ink Q ejection continues until the sheet S has completely past side head 44a and side head 44b (see FIG. 3, FIG. 4).

Note that this first specific time is the time required for the edge area S4 at the trailing end in the the conveyance direction of the sheet S to reach the side head 44a and side head 44b, and is previously set based on the conveyance speed of the sheet S and the distance on the X-axis between the position detector 5 and the side head 44a (side head 44b).

When a second specific time has past after detection by the position detector 5, ejection of ink Q by the top head 43a starts (see FIG. 3). This ink ejection continues until just before (slightly before) the sheet S has completely past the top head 43a, for example (see FIG. 4).

Note that this second specific time is the time until just before (slightly before) the edge area S4 at the leading end in the conveyance direction of the sheet S reaches the top head 43a, and is previously set based on the conveyance speed of the sheet S and the distance on the X-axis between the position detector 5 and the top head 43a.

When a third specific time has past after detection by the position detector 5, ejection of ink Q by the top head 43b starts (see FIG. 5). This ink ejection continues until ink Q has been applied to the entire side edge areas S4 of the sheet S to the trailing end in the conveyance direction.

Note that this third specific time is the time until just after (slightly after) the edge area S4 at the leading end in the conveyance direction of the sheet S reaches the top head 43b, and is previously set based on the conveyance speed of the sheet S and the distance on the X-axis between the position detector 5 and the top head 43b.

Next, as shown in FIG. 6, the sheet S is dried by the dryer 29 and compressed by the compression unit 30. Next, the sheet S is discharged from the sheet manufacturing apparatus 100. The manufactured sheet S thus passes through the paper dust suppression process and discharged without wrinkles or other unintended deformities. The sheet S can then be used for color printing, for example.

As described above, a paper strengthener coating device 1 according to this embodiment has a position detector 5 that detects the position of the sheet S relative to the inkjet head 42. Based on the detection result of the position detector 5, the controller 28 of the paper strengthener coating device 1 controls the ejection timing (ejection start and ejection end) when ink Q (solution) is ejected from the nozzles 45. As a result, when coating a sheet S with ink Q, the ink Q can be completely and accurately applied to the target areas of the sheet S (such as the edge areas S4 and inside area S5 of the sheet S).

A sheet S to which the paper dust suppression process was applied is described next with reference to FIG. 15 to FIG. 17.

If the content (%) of the paper strengthener in the edge areas S4 of the manufactured sheet S is X, and the content (%) of the paper strengthener in the inside area S5 between the edge areas S4 of the manufactured sheet S is Y, the ratio X/Y between X and Y is greater than or equal to 1.1 and less than or equal to 100, is preferably greater than or equal to 2 and less than or equal to 30, is further preferably greater than or equal to 10 and less than or equal to 20.

If the application area of the paper strengthener at the ends S3 of the edge areas S4 of the manufactured sheet S is A, and the application area of the paper strengthener in a transverse plane at a selected part of the inside area S5 between the edge areas S4 of the sheet S is B, the ratio A/B between A and B is greater than or equal to 2, is preferably greater than or equal to 2.5 and less than or equal to 10, is further preferably greater than or equal to 50 and less than or equal to 100.

A sheet S as described above is made by desirably adjusting various production conditions when making a sheet S (particularly ink Q coating conditions). If ratio X/Y and ratio A/B are in the numeric ranges described above, production of paper dust from the sheet S when printing on the sheet S can be suppressed, and paper dust clogging the nozzles of the printer, for example, can be prevented.

Note that whether or not ratio X/Y and ratio A/B are in the numeric ranges described above can be checked using an electron microscope, such as a scanning electron microscope, for example.

### Embodiment 2

FIG. 18 is a plan view illustrating the operation of a paper strengthener coating device according to a second embodiment of the invention.

A paper strengthener coating device, sheet manufacturing apparatus, sheet, and paper strengthener coating method according to a second embodiment of the invention are described below with reference to accompanying figures, focusing on differences with the embodiment described above and omitting redundant description of identical content.

This embodiment is identical to the first embodiment except for the operation of the top heads.

As shown in FIG. 18, in this embodiment, top head 43a stops ejecting ink Q to the inside area S5 of the sheet S. As a result, application of ink Q to the inside area S5 can be omitted. The top head 43a (inkjet head 42) in this embodiment is thus configured to prioritize application of ink Q to the edge areas S4 over application to the inside area S5 of the sheet S.

Note that stopping application of ink Q is done by the controller 28 controlling operation of the piezoelectric actuators 475 of the nozzles 45 corresponding to the inside nozzles (the nozzles that eject ink Q to the inside area S5).

The controller 28 also determines based on the detection result from the position detector 5 when the top head 43a is over the inside area S5 of the sheet S.

### Embodiment 3

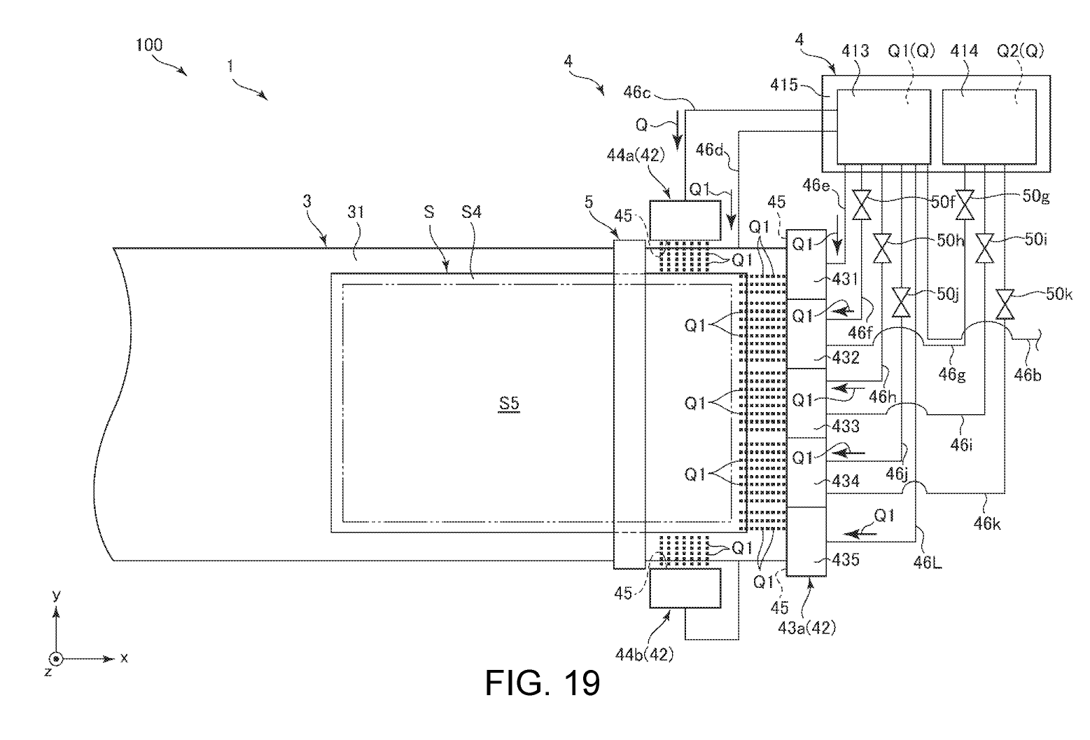

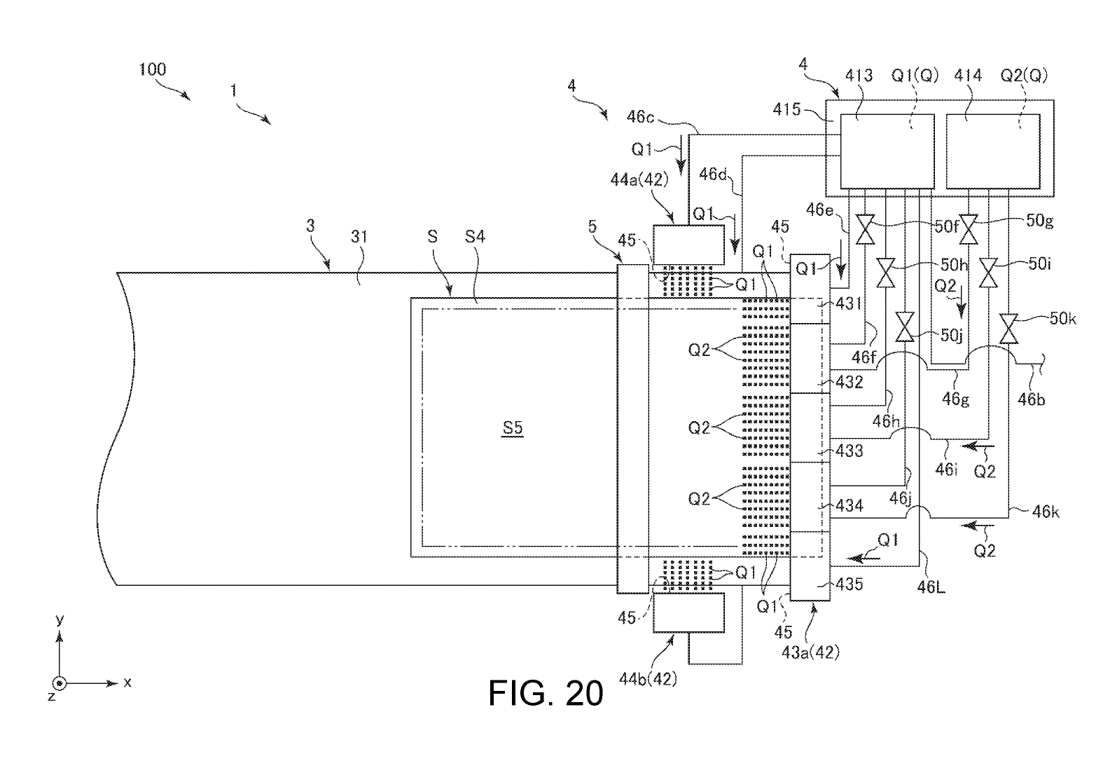

FIG. 19 and FIG. 20 are plan views sequentially illustrating the operation of a paper strengthener coating device according to the third embodiment of the invention.

A paper strengthener coating device, sheet manufacturing apparatus, sheet, and paper strengthener coating method according to a third embodiment of the invention are described below with reference to accompanying figures, focusing on differences with the embodiments described above and omitting redundant description of identical content.

This embodiment is identical to the first embodiment except for the configuration of the coating unit (paper strengthener coating unit).

As shown in FIG. 19 and FIG. 20, this embodiment uses multiple inks Q (solutions), a first ink Q1 (first solution) and a second ink Q2 (second solution) having different characteristics (particularly, permeability). Both first ink Q1 and second ink Q2 contain a paper strengthener, but the permeability of first ink Q1 and second ink Q2 differ. More specifically, first ink Q1 has greater permeability than second ink Q2. The method of making the permeability different is not specifically limited, and may involve using different types of solvents or compositions.

The ink supply unit 41 supplies the first ink Q1 (first solution) and second ink Q2 (second solution), and has a tank 413 that holds the first ink Q1, a tank 414 that holds the second ink Q2, and a loading unit 415 to which the tank 413 and tank 414 are installed.

The top head 43a is connected by a fluid-tight connection to the tank 413 through a conduit 46e. As a result, first ink Q1 is supplied from the tank 413 to the first unit 431.

The second unit 432 of the top head 43a is connected by a fluid-tight connection to the tank 413 through a conduit 46f. As a result, first ink Q1 can be supplied from the tank 413 to the second unit 432. A solenoid valve 50f is also disposed to the conduit 46f. Operation of the solenoid valve 50f is controlled by the controller 28, thereby enabling turning the supply of first ink Q1 to the second unit 432 on or off.

The second unit 432 is also connected by a fluid-tight connection to the tank 414 through a conduit 46g. As a result, second ink Q2 can be supplied from the tank 414 to the second unit 432. A solenoid valve 50g is also disposed to the conduit 46g. Operation of the solenoid valve 50g is controlled by the controller 28, thereby enabling turning the supply of second ink Q2 to the second unit 432 on or off.

As described above, the coating unit 4 (paper strengthener coating unit) has a solenoid valve 50f and a solenoid valve 50g as switching devices for turning the supply of first ink Q1 (first solution) (see FIG. 19) and second ink Q2 (second solution) (see FIG. 20) to the second unit 432 of the top head 43a on or off.

The third unit 433 of the top head 43a is connected by a fluid-tight connection to the tank 413 through a conduit 46h. As a result, first ink Q1 can be supplied from the tank 413 to the third unit 433. A solenoid valve 50h is also disposed to the conduit 46h. Operation of the solenoid valve 50h is controlled by the controller 28, thereby enabling turning the supply of first ink Q1 to the third unit 433 on or off.

The third unit 433 is also connected by a fluid-tight connection to the tank 414 through a conduit 46i. As a result, second ink Q2 can be supplied from the tank 414 to the third unit 433. A solenoid valve 50i is also disposed to the conduit 46i. Operation of the solenoid valve 50i is controlled by the controller 28, thereby enabling turning the supply of second ink Q2 to the third unit 433 on or off.

As described above, the coating unit 4 (paper strengthener coating unit) has a solenoid valve 50h and a solenoid valve 50i as switching devices for turning the supply of first ink Q1 (first solution) (see FIG. 19) and second ink Q2 (second solution) (see FIG. 20) to the third unit 433 of the top head 43a on or off.

The fourth unit 434 of the top head 43a is connected by a fluid-tight connection to the tank 413 through a conduit 46j. As a result, first ink Q1 can be supplied from the tank 413 to the fourth unit 434. A solenoid valve 50j is also disposed to the conduit 46j. Operation of the solenoid valve 50j is controlled by the controller 28, thereby enabling turning the supply of first ink Q1 to the fourth unit 434 on or off.

The fourth unit 434 is also connected by a fluid-tight connection to the tank 414 through a conduit 46k. As a result, second ink Q2 can be supplied from the tank 414 to the fourth unit 434. A solenoid valve 50k is also disposed to the conduit 46k. Operation of the solenoid valve 50k is controlled by the controller 28, thereby enabling turning the supply of second ink Q2 to the fourth unit 434 on or off.

As described above, the coating unit 4 (paper strengthener coating unit) has a solenoid valve 50j and a solenoid valve 50k as switching devices for turning the supply of first ink Q1 (first solution) (see FIG. 19) and second ink Q2 (second solution) (see FIG. 20) to the fourth unit 434 of the top head 43a on or off.

The fifth unit 435 of the top head 43a is connected by a fluid-tight connection to the tank 413 through a conduit 46L. As a result, first ink Q1 is supplied from the tank 413 to the fifth unit 435.

This configuration enables coating the edge areas S4 of the sheet S with a first ink Q1 having high permeability, and coating the inside area S5 of the sheet S with a second ink Q2 having low permeability. As a result, first ink Q1 can be applied to permeate mainly the edge areas S4 where paper dust is easily produced and sufficiently achieve the desired effect of the paper strengthener contained in the first ink Q1. The inside area S5 is the main printing area of the sheet S. As a result, inhibiting the adhesion of color ink in the inside area S5 can be prevented by applying second ink Q2 with low permeability in the inside area S5.

Note that the permeability of the first ink Q1 and second ink Q2 differs in this example, but the invention is not so limited. For example, the first ink Q1 and second ink Q2 may be formulated so that a different characteristic, such as the drying rate, differs.

### Embodiment 4

FIG. 21 is a partial section view illustrating the operation of a paper strengthener coating device according to a fourth embodiment of the invention.

A paper strengthener coating device, sheet manufacturing apparatus, sheet, and paper strengthener coating method according to a fourth embodiment of the invention are described below with reference to accompanying figures, focusing on differences with the embodiments described above and omitting redundant description of identical content.

This embodiment is identical to the first embodiment except for the configuration of the coating unit (paper strengthener coating unit).

As shown in FIG. 21, the coating unit 4 (paper strengthener coating unit) in this embodiment has a roller 48 as an ink transfer member (solution transfer member) that transfers ink Q (solution) to coat the sheet S, and a moving mechanism 49 that moves the roller 48 up and down (on the Z-axis). The roller 48 replaces top head 43a and top head 43b.

The roller 48 is an idler roller including a cylindrical core 481 and an ink retainer 482 disposed to the outside surface of the core 481. The ink retainer 482 is a porous member with a layered configuration for holding ink Q. When in contact with the sheet S, the roller 48 can turn in conjunction with sheet S conveyance in the direction of arrow α₄₈ on an axis of rotation O₄₈. As a result, ink Q held by the ink retainer 482 is transferred to the top surface S1 of the sheet S, and the entire top surface S1 is coated.

The moving mechanism 49 moves the roller 48 between a first position (the position of the roller 48 indicated by the solid lines in FIG. 21) and a second position (the position of the roller 48 indicated by the dot-dot-dash lines in FIG. 21). The moving mechanism 49 may be configured with a linear guide, for example.

When in the first position, the roller 48 is touching the sheet S and can apply ink Q to the top surface S1. In the second position, the roller 48 is separated from the sheet S, and application of ink Q to the top surface S1 stops. This embodiment therefore enables selectively applying or not applying ink Q to the top surface S1 by operating the moving mechanism 49.

The ink transfer member for transferring ink Q and coating the sheet S is a roller 48 in this example, but the invention is not so limited. For example, brush or squeegee may be used.

The ink transfer member may also be omitted in this embodiment. In this case, the sheet S is preferably formed with imbedded paper strengthener.

### Embodiment 5

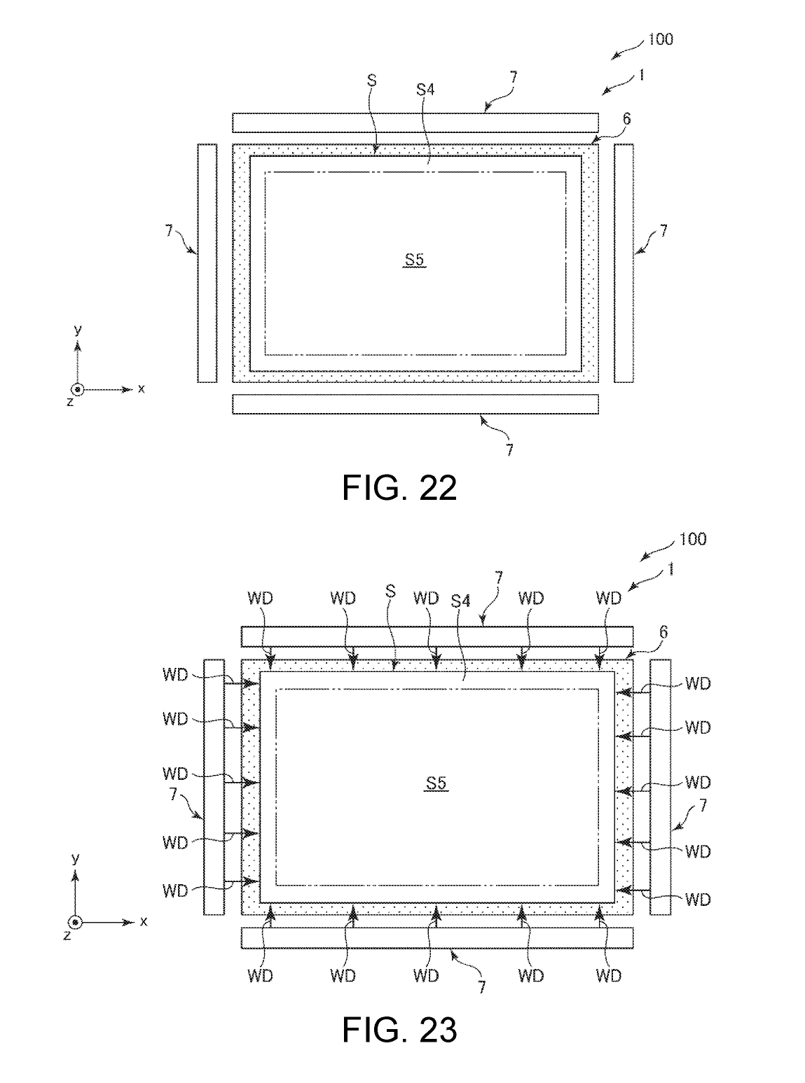

FIG. 22 and FIG. 23 are plan views illustrating the operation of a paper strengthener coating device according to a fifth embodiment of the invention.

A paper strengthener coating device, sheet manufacturing apparatus, sheet, and paper strengthener coating method according to a fifth embodiment of the invention are described below with reference to accompanying figures, focusing on differences with the embodiments described above and omitting redundant description of identical content.

This embodiment is identical to the first embodiment except for the method of applying ink to a sheet.

As shown in FIG. 22 and FIG. 23, a sheet S in this embodiment is placed on a plastic platen 6 that is larger than the sheet S. Ink Q is then applied so that the ink Q overflows into the area surrounding the sheet S. The ink Q is applied in this manner by the inkjet head 42.

Multiple blowers 7 (four in this example) are disposed around the platen 6 and blow air WD toward the sheet S on the platen 6. The air WD current from the blowers 7 pushes the ink Q around the sheet S to the sides of the sheet S, causing the ink Q to permeate the edge areas S4. As a result, ink Q can be selectively applied to the edge areas S4 of the sheet S.

### Embodiment 6

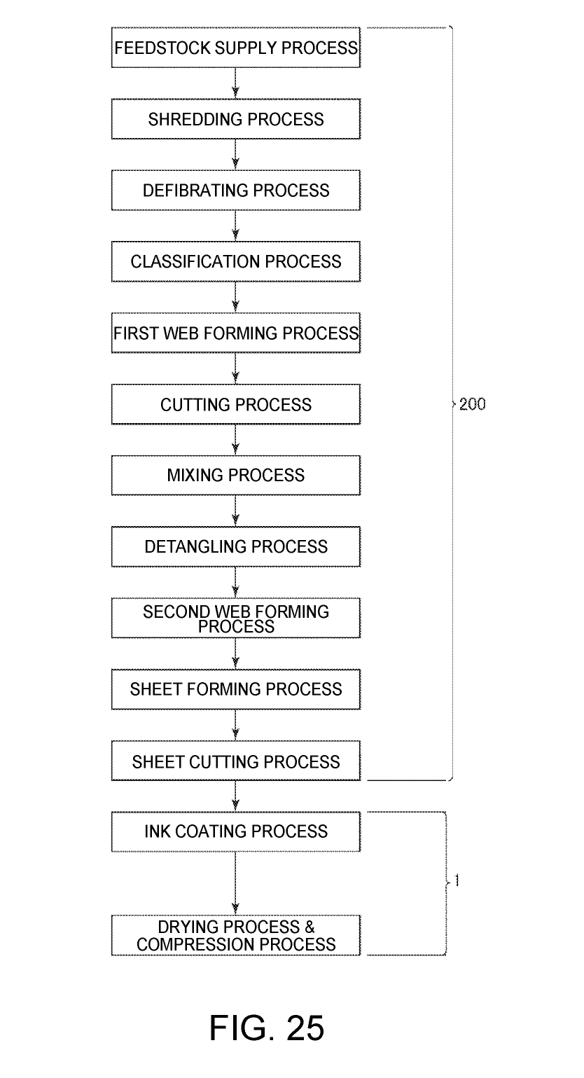

FIG. 24 schematically illustrates the configuration of a sheet manufacturing apparatus according to a sixth embodiment of the invention. FIG. 25 sequentially shows processes executed by the sheet manufacturing apparatus according to the sixth embodiment of the invention.

A paper strengthener coating device, sheet manufacturing apparatus, sheet, and paper strengthener coating method according to a sixth embodiment of the invention are described below with reference to accompanying figures, focusing on differences with the embodiments described above and omitting redundant description of identical content.

This embodiment is identical to the first embodiment except for the configuration of the sheet manufacturing apparatus.

As shown in FIG. 24, the sheet manufacturing apparatus 100 according to this embodiment has a preprocessing system 200. The preprocessing system 200 is a system that manufactures the sheet S to which ink Q is then applied by the paper strengthener coating device 1.

The preprocessing system 200 includes a feedstock supply device 11, a shredder 12, a defibrator 13, a classifier 14, a first web forming device 15, a cutter 16, a mixing device 17, a detangler 18, a second web forming device 19, a sheet forming device 20, a paper cutter 21, a stacker 22, and a dust collector 27. The preprocessing system 200 also has also has wetting unit 231, wetting unit 232, wetting unit 233, wetting unit 234, wetting unit 235, and wetting unit 236. The sheet manufacturing apparatus 100 also has a blower 261, blower 262, and blower 263.

Operation of the parts of the preprocessing system 200 may be controlled by the controller 28, or controlled by the another controller disposed to the preprocessing system 200 separately from the controller 28. The controller may be integrated into the preprocessing system 200, or disposed to an external device such as an external compute. Such an external device may be connected to the preprocessing system 200 through a cable, wirelessly, or connected to the preprocessing system 200 through a network (such as the Internet).

As shown in FIG. 25, the preprocessing system 200 sequentially executes a feedstock supply process, a shredding process, a defibrating process, a classification process, a first web forming process, a cutting process, a mixing process, a detangling process, a second web forming process, a sheet forming process, and a sheet cutting process. After processing by the preprocessing system 200 is completed, the sheet S moves to the paper strengthener coating device 1, and is processed by the paper strengthener coating device 1, specifically the ink coating process and following processes.

The configuration of parts of the preprocessing system 200 is described below.

The feedstock supply device 11 is the part that executes the feedstock supply process of supplying feedstock M1 (material) to the shredder 12. The feedstock M1 is a sheet material containing fiber (cellulose fiber).

Note that the cellulose fiber may be any fibrous material containing mainly cellulose (narrowly defined cellulose) as a chemical compound, and in addition to cellulose (narrowly defined cellulose) may include hemicellulose or lignin. The form of the feedstock M1 is not specifically limited, and the feedstock M1 may be woven cloth or non-woven cloth. The feedstock M1 may also be recycled paper manufactured (regenerated) by defibrating recovered paper, or synthetic Yupo paper (R), and does not need to be recycled paper.

The shredder 12 is the part that executes the shredding process of shredding the feedstock M1 supplied from the feedstock supply device 11 in air (ambient air). The shredder 12 has a pair of shredder blades 121 and a chute (hopper) 122.

By turning in mutually opposite directions of rotation, the pair of shredder blades 121 shred the feedstock M1 passing therebetween, that is, cut the feedstock M1 into small shreds M2. The size and shape of the shreds M2 are preferably appropriate to the defibration process of the defibrator 13, and in this example are preferably pieces 100 mm or less on a side, and are further preferably pieces that are greater than or equal to 10 mm and less than or equal to 70 mm per side.

The chute 122 is located below the pair of shredder blades 121, and in this example is funnel-shaped. As a result, the chute 122 can easily catch the shreds M2 that are shredded and dropped by the shredder blades 121.

Above the chute 122, a wetting unit 231 is disposed beside the pair of shredder blades 121. The wetting unit 231 wets the shreds M2 in the chute 122. This wetting unit 231 has a filter (not shown in the figure) containing water, and is configured as a heaterless humidifier (or heated humidifier) that supplies a moist stream of air to the shreds M2 by passing air through the filter. By wet air being supplied to the shreds M2, shreds M2 sticking to the chute 122 due to static electricity can be suppressed.

The chute 122 connects to the defibrator 13 through a conduit (flow channel) 241. The shreds M2 collected in the chute 122 passes through the conduit 241 and are conveyed to the defibrator 13.

The defibrator 13 is the part that executes the defibrating process that defibrates the shreds M2 in a dry process in air. Defibrated material M3 can be produced from the shreds M2 by the defibration process of the defibrator 13.

As used herein, defibrate means to break apart and detangle into single individual fibers shreds M2 composed of many fibers bonded together. The resulting detangled fibers are the defibrated material M3. The shape of the defibrated material M3 is strands and ribbons. The defibrated material M3 may also contain clumps, which are multiple fibers tangled together into clumps.

The defibrator 13 in this embodiment of the invention, for example, is configured as an impeller mill having a rotor that turns at high speed, and a liner disposed around the rotor. Shreds M2 introduced to the defibrator 13 are defibrated between the rotor and the liner.

The defibrator 13, by rotation of the rotor, produces an air flow (current) from the shredder 12 to the classifier 14. As a result, shreds M2 can be suctioned from the conduit 241 to the defibrator 13. In addition, after the defibration process, the defibrated material M3 can be fed through another conduit 242 to the classifier 14.

A blower 261 is disposed in the conduit 242. The blower 261 is an air flow generator that produces a flow of air to the classifier 14. Conveyance of the defibrated material M3 to the classifier 14 is thereby promoted.

The classifier 14 is the part that executes the classification process of classifying the defibrated material M3 based on the length of the fibers. In the classifier 14, the defibrated material M3 is separated into first screened material M4-1, and second screened material M4-2 that is larger than the first screened material M4-1. The first screened material M4-1 is of a size appropriate to manufacturing sheets S downstream.

The average length of the fibers is preferably greater than or equal to 100 μm and less than or equal to 10 mm.

The second screened material M4-2 includes, for example, fiber that has not been sufficiently defibrated, and excessively agglomerated (clumped) defibrated fibers.

The classifier 14 includes a drum 141, and a housing 142 enclosing the drum 141.

The drum 141 is a sieve comprising a cylindrical mesh body that rotates on its center axis. The defibrated material M3 is introduced to the drum 141. By the drum 141 rotating, defibrated material M3 that is smaller than the mesh passes through and is separated as first screened material M4-1, and defibrated material M3 that is larger than the mesh and therefore does not pass through, is separated as second screened material M4-2.

The first screened material M4-1 drops from the drum 141.

The second screened material M4-2 is discharged to the conduit (flow path) 243 connected to the drum 141. The end of the conduit 243 on the opposite end (downstream end) as the drum 141 is connected to another conduit 241. The second screened material M4-2 that past through the conduit 243 merges with the shreds M2 inside the conduit 241, and is introduced with the shreds M2 to the defibrator 13. As a result, the second screened material M4-2 is returned to the defibrator 13 and past through the defibrating process with the shreds M2.

The first screened material M4-1 from the drum 141 is dispersed while dropping through air, and descends toward the first web forming device 15 (separator). The first web forming device 15 is the part that executes a first web forming process forming a first web M5 from the first screened material M4-1. The first web forming device 15 includes a mesh belt (separation belt) 151, three tension rollers 152, and a suction unit (suction mechanism) 153.

The mesh belt 151 is an endless belt on which the first screened material M4-1 accumulates. This mesh belt 151 is mounted on three tension rollers 152. By rotationally driving the tension rollers 152, the first screened material M4-1 deposited on the mesh belt 151 is conveyed downstream.

The size of the first screened material M4-1 is greater than or equal to the size of the mesh in the mesh belt 151. As a result, passage of the first screened material M4-1 through the mesh belt 151 is limited, and as a result the first screened material M4-1 accumulates on the mesh belt 151. Furthermore, because the first screened material M4-1 is conveyed downstream by the mesh belt 151 as the first screened material M4-1 accumulates on the mesh belt 151, the first screened material M4-1 is formed in a layer as a first web M5.

The first screened material M4-1 may also contain dust, dirt, and other material. Dust and dirt, for example, may be produced by shredding and defibration. Such dust and dirt is later recovered in the dust collector 27 described below.

The suction unit 153 suctions air from below the mesh belt 151. As a result, dust and dirt that has past through the mesh belt 151 can be suctioned together with the air.

The suction unit 153 is connected to a dust collector 27 (recovery device) through another conduit (flow path) 244. Dust and dirt suctioned by the suction unit 153 is captured by the dust collector 27.

Another conduit (flow path) 245 is also connected to the dust collector 27. A blower 262 is disposed to the conduit 245. Operation of the blower 262 produces suction in the suction unit 153. This promotes formation of the first web M5 on the mesh belt 151. Dust and dirt has been removed from the material forming the first web M5. Operation of the blower 262 causes the dust and dirt to pass through the conduit 244 and reach the dust collector 27.

The housing 142 is connected to a wetting unit 232. Like the wetting unit 231 described above, the wetting unit 232 is a heaterless humidifier. As a result, wet air is supplied into the housing 142. This wet air moistens the first screened material M4-1, and as a result can suppress sticking of the first screened material M4-1 to the inside walls of the housing 142 due to static electricity.

Another wetting unit 235 is disposed downstream from the classifier 14. This wetting unit 235 is configured as an ultrasonic humidifier that mists water. As a result, moisture can be supplied to the first web M5, and the moisture content of the first web M5 can thereby be adjusted. This adjustment can also suppress sticking of the first web M5 to the mesh belt 151 due to static electricity. As a result, the first web M5 easily separates from the mesh belt 151 at the tension roller 152 from where the mesh belt 151 returns to the upstream side.

On the downstream side of the wetting unit 235 is a cutter 16. The cutter 16 is apart that executes a cutting process of cutting the first web M5 that has separated from the mesh belt 151.

The cutter 16 has a propeller 161 that is rotationally supported, and a housing 162 that houses the propeller 161. The first web M5 is cut into pieces as it is fed into the rotating propeller 161. The cut first web M5 forms segments M6. The segments M6 then drop down in the housing 162.

The housing 162 is connected to another wetting unit 233. Like the wetting unit 231 described above, the wetting unit 233 is a heaterless humidifier. As a result, wet air is supplied into the housing 162. This wet air suppresses sticking of the segments M6 to the propeller 161 and to the inside walls of the housing 162 due to static electricity.

A mixing device 17 is disposed on the downstream side of the cutter 16. The mixing device 17 is the part that executes a mixing process of mixing the segments M6 with resin P1. The mixing device 17 includes a resin supply device 171, a conduit (flow path) 172, and a blower 173.

The conduit 172 connects to the housing 162 of the cutter 16 and the housing 182 of the detangler 18, and is a flow path through which a mixture M7 of the segments M6 and resin P1 passes.

The resin supply device 171 connects to the conduit 172. The resin supply device 171 has a screw feeder 174. By rotationally driving the screw feeder 174, the resin P1 can be supplied in powder or particle form to the conduit 172. The resin P1 supplied to the conduit 172 is mixed with the segments M6, forming the mixture M7.

Note that the resin P1 bonds fibers together in a downstream process, and may be a thermoplastic resin or a thermosetting resin, but is preferably a thermoplastic resin. Examples of such thermoplastic resins include AS resin, ABS resin, polyethylene, polypropylene, ethylene-vinylacetate copolymer (EVA), or other polyolefin, denatured polyolefins, polymethylmethacrylate or other acrylic resin, polyvinyl chloride, polystyrene, polyethylene terephthalate, polybutylene terephthalate or other polyesters, nylon 6, nylon 46, nylon 66, nylon 610, nylon 612, nylon 11, nylon 12, nylon 6-12, nylon 6-66 or other polyimide (nylon), polyphenylene ether, polyacetal, polyether, polyphenylene oxide, polyether ether ketone, polycarbonate, polyphenylene sulfide, thermoplastic polyimide, polyether imide, aromatic polyester, or other liquid crystal polymer, styrenes, polyolefins, polyvinyl chlorides, polyurethanes, polyesters, polyimides, polybutadienes, transpolyisoprenes, fluoroelastomers, polyethylene chlorides and other thermoplastic elastomers, as well as combinations of one or two or more of the foregoing. Preferably, a polyester or resin containing a polyester is used as the thermoplastic resin.

Additives other than resin P1 may also be supplied from the resin supply device 171, including, for example, coloring agents for adding color to the fiber, anti-blocking agents for suppressing clumping of the fiber and clumping of the resin P1, and flame retardants for making the fiber and manufactured sheets difficult to burn. Compounds already incorporating such other additives with the resin P1 may also be supplied from the resin supply device 171.

The blower 173 is disposed to the conduit 172 downstream from the resin supply device 171. The segments M6 and resin P1 are also mixed by the action of a rotating unit such as blades of the blower 173. The blower 173 is configured to produce an air current toward the detangler 18. This air current can also mix the segments M6 and resin P1 inside the conduit 172. As a result, the mixture M7 can be introduced to the detangler 18 as a uniform dispersion of the segments M6 and resin P1. The segments M6 in the mixture M7 are further detangled into smaller fibers while travelling through the conduit 172.

The detangler 18 is the part that executes the detangling process that detangles interlocked fibers in the mixture M7.

The detangler 18 includes a drum 181 and a housing 182 that houses the drum 181.

The drum 181 is a sieve comprising a cylindrical mesh body that rotates on its center axis. The mixture M7 is introduced to the drum 181. By the drum 181 rotating, fiber in the mixture M7 that is smaller than the mesh can pass through the drum 181. The mixture M7 is detangled in this process.

The mixture M7 that is detangled in the drum 181 is dispersed while dropping through air, and falls to the second web forming device 19 located below the drum 181. The second web forming device 19 is the part that executes the second web forming process forming a second web M8 from the mixture M7. The second web forming device 19 includes a mesh belt (separation belt) 191, tension rollers 192, and a suction unit (suction mechanism) 193.

The mesh belt 191 is an endless belt on which the mixture M7 accumulates. This mesh belt 191 is mounted on four tension rollers 192. By rotationally driving the tension rollers 192, the mixture M7 deposited on the mesh belt 191 is conveyed downstream.

Most of the mixture M7 on the mesh belt 191 is larger than the mesh in the mesh belt 191. As a result, the mixture M7 is suppressed from passing through the mesh belt 191, and therefore accumulates on the mesh belt 191. The mixture M7 is conveyed downstream by the mesh belt 191 as the mixture M7 accumulates on the mesh belt 191, and is formed in a layer as the second web M8.

The suction unit 193 suctions air down from below the mesh belt 191. As a result, the mixture M7 can be pulled onto the mesh belt 191, and accumulation of the mixture M7 on the mesh belt 191 is thereby promoted.

Another conduit (flow path) 246 is connected to the suction unit 193. A blower 263 is also disposed to the conduit 246. Operation of the blower 263 produces suction in the suction unit 193.

Another wetting unit 234 is connected to the housing 182. Like the wetting unit 231 described above, the wetting unit 234 is a heaterless humidifier. As a result, wet air is supplied into the housing 182. By humidifying the inside of the housing 182 by adding wet air, sticking of the mixture M7 to the inside walls of the housing 182 due to static electricity can be suppressed.

Another wetting unit 236 is disposed below the detangler 18. This wetting unit 236 is configured as an ultrasonic humidifier similarly to the wetting unit 235 described above. As a result, moisture can be supplied to the second web M8, and the moisture content of the second web M8 can thereby be adjusted. This adjustment can also suppress sticking of the second web M8 to the mesh belt 191 due to static electricity. As a result, the second web M8 easily separates from the mesh belt 191 at the tension roller 192 from where the mesh belt 191 returns to the upstream side.

Note that the amount of moisture (total moisture content) added by wetting unit 231 to wetting unit 236 is, for example, preferably greater than or equal to 0.5 parts by weight and less than or equal to 20 parts by weight per 100 parts by weight of the material before adding moisture.

A sheet forming device 20 is disposed downstream from the second web forming device 19. The sheet forming device 20 is the part that executes the sheet forming process forming sheets S from the second web M8. This sheet forming device 20 includes a calender 201 and a heater 202.

The calender 201 comprises a pair of calender rolls 203, and the second web M8 can be compressed without heating (without melting the resin P1) by passing the second web M8 between the calender rolls 203. This process increases the density of the second web M8. The second web M8 is then conveyed toward the heater 202. Note that one of the pair of calender rolls 203 is a drive roller that is driven by operation of a motor (not shown in the figure), and the other is a driven roller.

The heater 202 has a pair of heat rollers 204, which can heat while compressing the second web M8 passing between the heat rollers 204. The combination of heat and pressure melts the resin P1 in the second web M8, and bonds fibers through the molten resin P1. As a result, a sheet S is formed.

The sheet S is then conveyed to the paper cutter 21. Note that one of the pair of heat rollers 204 is a drive roller that is driven by operation of a motor (not shown in the figure), and the other is a driven roller.

A paper cutter 21 is disposed downstream from the sheet forming device 20. The paper cutter 21 is the part that executes the sheet cutting process that cuts the continuous sheet S into single sheets S. The paper cutter 21 includes a first cutter 211 and a second cutter 212.

The first cutter 211 cuts the sheet S in the direction crosswise to the conveyance direction of the sheet S.

The second cutter 212 is downstream from the first cutter 211, and cuts the sheets S in the direction parallel to the conveyance direction of the sheet S.

Sheets S of a desired size are produced by the cutting action of the first cutter 211 and the second cutter 212. The sheets S are then conveyed further downstream and stacked in a stacker 22.

The sheets S accumulated in the stacker 22 are then moved to the coating device 1 and ink Q is applied.

A paper strengthener coating device, sheet manufacturing apparatus, sheet, and paper strengthener coating method according to the invention are described above, but the invention is not so limited. The parts embodying the paper strengthener coating device and sheet manufacturing apparatus may be replaced by other desirable configurations having the same function or capability. Other desirable configurations may also be added.

The paper strengthener coating device, sheet manufacturing apparatus, sheet, and paper strengthener coating method according to the invention may also combine configurations or features from any two or more of the foregoing embodiments.

The paper strengthener coating device may also have a thickness detector for detecting the thickness of the sheet. In this case, the controller, based on the detection result from the thickness detector, can adjust the amount of ink ejected from the nozzles of the inkjet head. This enables applying paper strengthener appropriately according to the thickness of the sheet.

Furthermore, the top head is disposed to a fixed position in the embodiments described above, but the invention is not so limited, and the top head may be supported movably (bidirectionally) on the Y-axis.

In addition, the side heads are disposed to a fixed position in the embodiments described above, but the invention is not so limited, and the top head may be supported movably on the X-axis or Y-axis.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2017-189223, filed Sep. 28, 2017 is expressly incorporated by reference herein.

What is claimed is:

1. A paper strengthener coating device comprising:
a solution supply device configured to supply a solution containing a paper strengthener;
an inkjet head having nozzles that eject the solution supplied from the solution supply device; and
a paper strengthener coating unit configured to apply the solution ejected from the nozzles onto a sheet;
the inkjet head preferentially or selectively applying the solution to an edge part of the sheet.

2. The paper strengthener coating device described in claim 1, further comprising:
a conveyance device configured to convey the sheet;
the inkjet head including a top head disposed above the sheet conveyed by the conveyance device and having multiple nozzles arrayed in a direction intersecting a conveyance direction of the sheet;
the top head ejecting the solution from the nozzles toward the edge part of the sheet as the sheet passes.

3. The paper strengthener coating device described in claim 2, wherein:
the multiple nozzles include inside nozzles facing an inside part between edge parts of the sheet, and the top head also ejects the solution from the inside nozzles to the inside part when the sheet passes.

4. The paper strengthener coating device described in claim 3, wherein:
the top head also has an adjustment means configured to set the amount of solution ejected to the edge part of the sheet different from the amount of solution ejected to the inside part of the sheet.

5. The paper strengthener coating device described in claim 2, wherein:
the solution includes a first solution and a second solution with different properties;
the solution supply device supplies the first solution and the second solution; and
the paper strengthener coating unit has a switching means configured to turn the supply of the first solution and the supply of the second solution to the top head on or off.

6. The paper strengthener coating device described in claim 2, wherein:
the nozzles of the top head open at an incline to the conveyance direction of the sheet.

7. The paper strengthener coating device described in claim 1, further comprising:
a conveyance device configured to convey the sheet;
the inkjet head including a side head disposed at a side of the sheet conveyed by the conveyance device and having multiple nozzles;
the side head ejecting the solution from the nozzles toward the edge part of the sheet as the sheet passes.

8. The paper strengthener coating device described in claim 1, wherein:
the paper strengthener coating unit has a solution transfer member configured to transfer the solution to and coat the sheet when in contact with the sheet.

9. The paper strengthener coating device described in claim 1, further comprising:
a controller configured to control operation of the inkjet head.

10. The paper strengthener coating device described in claim 9, further comprising:
a position detector configured to detect a position of the sheet relative to the inkjet head;
the controller controlling an ejection timing for ejecting the solution from the nozzles based on the detection result of the position detector.

11. The paper strengthener coating device described in claim 1, wherein:
the paper strengthener is a dry-strength additive.

12. A sheet manufacturing apparatus comprising a paper strengthener coating device described in claim 1.

13. A sheet wherein:
when a content (%) of paper strengthener in an edge part of a paper sheet is X, and a content (%) of paper strengthener in an inside area between the edge parts of the sheet is Y, the ratio X/Y between X and Y is greater than or equal to 1.1 and less than or equal to 100.

14. A sheet wherein:
when an application area of paper strengthener in an edge part of a paper sheet is A, and an application area of paper strengthener in a transverse plane of an inside part between the edge parts of the sheet is B, the ratio A/B between A and B is greater than or equal to 2.

15. A paper strengthener coating method comprising:
a coating step of applying a solution including a paper strengthener to a paper sheet;
the coating step using an inkjet head to preferentially or selectively apply the solution to an edge part of the sheet.
